(19) United States
(12) Patent Application Publication
(10) Pub. No.: US 2017/0213222 A1
(43) Pub. Date: Jul. 27, 2017

(54) NATURAL LANGUAGE PROCESSING AND STATISTICAL TECHNIQUES BASED METHODS FOR COMBINING AND COMPARING SYSTEM DATA

(71) Applicant: GM GLOBAL TECHNOLOGY OPERATIONS LLC, Detroit, MI (US)

(72) Inventors: DNYANESH RAJPATHAK, TROY, MI (US); PRAKASH M. PERANANDAM, TROY, MI (US); SOUMEN DE, BANGALORE (IN); JOHN A. CAFEO, FARMINGTON, MI (US); JOSEPH A. DONNDELINGER, WOODWAY, TX (US); PULAK BANDYOPADHYAY, ROCHESTER HILLS, MI (US)

(73) Assignee: GM GLOBAL TECHNOLOGY OPERATIONS LLC, Detroit, MI (US)

(21) Appl. No.: 15/481,205

(22) Filed: Apr. 6, 2017

Related U.S. Application Data
(63) Continuation-in-part of application No. 14/032,022, filed on Sep. 19, 2013.

(51) Int. Cl. G06Q 30/00; G06F 17/18; G06F 17/16; G06F 17/27

(52) U.S. Cl. CPC G06Q 30/012; G06F 17/2715; G06F 17/2785; G06F 17/18; G06F 17/16

(57) ABSTRACT

Methods and systems are provided for automatically comparing, combining and fusing vehicle data. First data is obtained pertaining to a first plurality of vehicles. Second data is obtained pertaining to a second plurality of vehicles. One or both of the first data and the second data include abbreviated terms. The abbreviated terms are disambiguating at least in part by identifying, from a domain ontology stored in a memory, respective basewords that are associated with each of the abbreviated terms, filtering the basewords, performing a set intersection of the basewords, and calculating posterior probabilities for the basewords based at least in part on the filtering and the set intersection. The first data and the second data are combined, via a processor, based on semantic and syntactic similarity between respective data elements of the first data and the second data and the disambiguating of the abbreviated terms.

### CROSS-REFERENCES TO RELATED APPLICATIONS

This is a continuation-in-part of, and claims priority from, application Ser. No. 14/032,022, filed on Sep. 19, 2013, the entirety of which in incorporated by reference herein.

### TECHNICAL FIELD

The technical field generally relates to the field of vehicles and, more specifically, to natural language processing and statistical techniques based methods for combining and comparing system data.

### BACKGROUND

Today data is generated for vehicles from various sources at various times in the life cycle of the vehicle. For example, data may be generated whenever a vehicle is taken to a service station for maintenance and repair, it is also generated during early stages of vehicle design and development via design failure mode and effects analysis (DFMEA). Because data is collected during different stages of vehicle development, analogous types of vehicle data may not always be recorded in a consistent manner. For example, in the case of certain vehicles having an issue with a window in the DFMEA data the related failure modes may be recorded as ‘window not operating correctly’ whereas when a vehicle goes for servicing and repair one technician may record the issue as “window not operating correctly”, while another may use “window stuck”, yet another may use “window switch broken”, and so on. In other case, the issue is recorded by using the fault code (referred to as the diagnostic trouble code), as “Regulator U1511”. Accordingly, it may be difficult to effectively combine such different vehicle data to find the new failure modes, effects and causes, for example that are observed in the warranty data which can be in-time augmented in the DFMEA data for further improving products and services of future releases.

Accordingly, it may be desirable to provide improved methods, program products, and systems for combining and comparing vehicle data, for example from different sources and identify the new failure modes or effects or causes observed at the time of failure for their augmentation in the data generated in the early stages of vehicle design and development, e.g. DFMEA. Furthermore, other desirable features and characteristics of the present disclosure will become apparent from the subsequent detailed description of the disclosure and the appended claims, taken in conjunction with the accompanying drawings and this background of the disclosure.

### SUMMARY

In accordance with an exemplary embodiment, a method is provided. The method comprises obtaining first data comprising data elements pertaining to a first plurality of vehicles; obtaining second data comprising data elements pertaining to a second plurality of vehicles, wherein one or both of the first data and the second data include one or more abbreviated terms; disambiguating the abbreviated terms at least in part by identifying, from a domain ontology stored in a memory, respective basewords that are associated with each of the abbreviated terms, filtering the basewords, performing a set intersection of the basewords, and calculating posterior probabilities for the basewords based at least in part on the filtering and the set intersection; and combining the first data and the second data, via a processor, based on semantic and syntactic similarity between respective data elements of the first data and the second data and the disambiguating of the abbreviated terms.

In accordance with an exemplary embodiment, a method is provided. The method comprises obtaining first data comprising data elements pertaining to a first plurality of vehicles, the first data comprising design failure mode and effects analysis (DFMEA) data that is generated using vehicle warranty claims; obtaining second data comprising data elements pertaining to a second plurality of vehicles, the second data comprising vehicle field data; combining the DFMEA data and the vehicle field data, based on syntactic similarity between respective data elements of the DMEA data and the vehicle field data; determining whether any particular failure modes have resulted in multiple warranty claims for the vehicle, based on the DFMEA data and the vehicle field data; and updating the DFMEA data based on the multiple warranty claims for the vehicle caused by the particular failure modes.

In accordance with a further exemplary embodiment, a system is provided. The system comprises a memory and a processor. The memory stores first data comprising data elements pertaining to a first plurality of vehicles and second data comprising data elements pertaining to a second plurality of vehicles. One or both of the first data and the second data include one or more abbreviated terms. The processor is coupled to the memory. The processor is configured to at least facilitate disambiguating the abbreviated terms at least in part by: identifying, from a domain ontology stored in a memory, respective basewords that are associated with each of the abbreviated terms, filtering the basewords, performing a set intersection of the basewords, and calculating posterior probabilities for the basewords based at least in part on the filtering and the set intersection; and combining the first data and the second data, via a processor, based on semantic and syntactic similarity between respective data elements of the first data and the second data and the disambiguating of the abbreviated terms.

### BRIEF DESCRIPTION OF THE DRAWINGS

Certain embodiments of the present disclosure will hereinafter be described in conjunction with the following drawing figures, wherein like numerals denote like elements, and wherein:

FIG. 1 is a functional block diagram of a system for automatically comparing and combining vehicle data collected during different stages of vehicle development process, and is depicted along with multiple data sources coupled to respective pluralities of vehicles, in accordance with an exemplary embodiment;

FIG. 2 is a flow diagram of a flow path for combining vehicle data, and that can be used in conjunction with the system of FIG. 1, in accordance with an exemplary embodiment;

FIG. 3 is a flowchart of a process for combining vehicle data corresponding to the flow diagram of FIG. 2, and that can be used in conjunction with the system of FIG. 1, in accordance with an exemplary embodiment;

FIG. 4 is a flowchart of a sub-process of the process of FIG. 3, namely, classifying elements from first data, in accordance with an exemplary embodiment;

FIG. 5 is a flowchart of another sub-process of the process of FIG. 2, namely, classifying elements from second data, in accordance with an exemplary embodiment;

FIG. 6 is a flowchart of another sub-process of the process of FIG. 3, namely, determining syntactic similarity between the first and second data, in accordance with an exemplary embodiment;

FIG. 7 is a flowchart of a sub-process for disambiguation of abbreviated terms, in accordance with an exemplary embodiment; and

FIG. 8 is a flowchart of a sub-process for analyzing DFMEA data, in accordance with an exemplary embodiment.

### DETAILED DESCRIPTION

The following detailed description is merely exemplary in nature, and is not intended to limit the disclosure or the application and uses thereof. Furthermore, there is no intention to be bound by any expressed or implied theory presented in the preceding technical field, background, or the following detailed description.

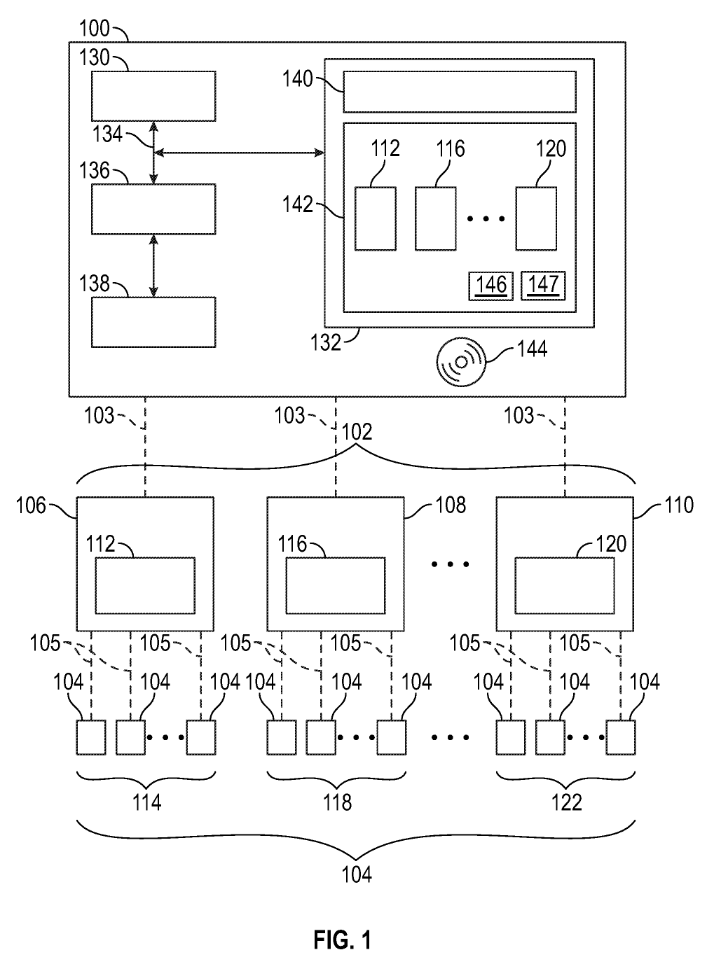

FIG. 1 is a functional block diagram of a system 100 for automatically comparing and combining vehicle data collected during different stages of vehicle development process, in accordance with an exemplary embodiment. The system 100 is depicted along with multiple sources 102 of vehicle data. The system 100 is coupled to the sources 102 via one or more communication links 103. In one embodiment, the system 100 is coupled to the sources 102 via one or more wireless networks 103, such as by way of example, a global communication network/Internet, a cellular connection, or one or more other types of wireless networks. Also in one embodiment, the sources 102 are each disposed in different geographic locations from one another and from the system 100, and the system 100 comprises a remote, or central, server location.

As depicted in FIG. 1, each of the sources 102 is coupled to a respective plurality of vehicles 104 via one or more wired or wireless connections 105, and generates vehicle data pertaining thereto. For example, a first source 106 generates first data 112 pertaining to a first plurality of vehicles 114 coupled thereto, a second source 108 generates second data 116 pertaining to a second plurality of vehicles 118 coupled thereto, an “nth” source 110 generates “nth” data 120 pertaining to an “nth” plurality of vehicles 122 coupled thereto, and so on. As noted by the “ . . . ” in FIG. 1, there may be any number of vehicle data sources 102, corresponding vehicle data, and/or pluralities of vehicles 104 in various embodiments.

Each source 102 may represent a different service station or other entity or location that generates vehicle data (for example, during vehicle maintenance or repair). The vehicle data may include any values or information pertaining to particular vehicles, including the mileage on the vehicle, maintenance records, any issues or problems that are occurring and/or that have been pointed out by the owner or driver of the vehicle, the causes of any such issues or problems, actions taken, performance and maintenance of various systems and parts, and so on.

At least one such source 102 preferably includes a source of manufacturer data for design failure mode and effects analysis (DFMEA). The DFMEA data is generated in the early stages of system design and development. It typically consists of different components in the system, the failure modes that can be expected in the system, the possible effect of the failure modes, and the cause of the failure mode. It also consists of PRN number associated with each failure mode, which indicates the severity of the failure mode if it is observed in the field. The DFMEA data is created by the experts in each domain and after they have seen the system analysis, which may include modeling, computer simulations, crash testing, and of course the field issues that have been observed in the past.

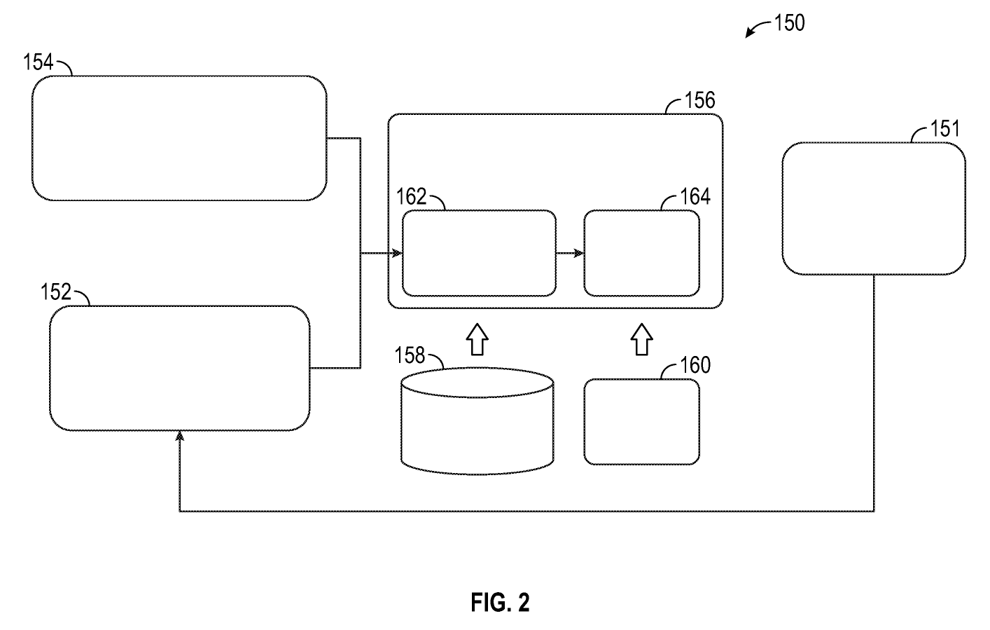

The vehicles for which the vehicle data pertain preferably comprise automobiles, such as sedans, trucks, vans, sport utility vehicles, and/or other types of automobiles. In certain embodiments the various pluralities of vehicles 102 (e.g. pluralities 114, 118, 122, and so on) may be entirely different, and/or may include some overlapping vehicles. In other embodiments, two or more of the various pluralities of vehicles 102 may be the same (for example, this may represent the entire fleet of vehicles of a manufacturer, in one embodiment). In either case, the vehicle data is provided by the various vehicle data sources 102 to the system 100 (e.g., a central server) for storage and processing, as described in greater detail below in connection with FIG. 1 as well as FIGS. 2-6.

As depicted in FIG. 1, the system 100 comprises a computer system (for example, on a central server that is disposed physically remote from one or more of the sources 102) that includes a processor 130, a memory 132, a computer bus 134, an interface 136, and a storage device 138. The processor 130 performs the computation and control functions of the system 100 or portions thereof, and may comprise any type of processor or multiple processors, single integrated circuits such as a microprocessor, or any suitable number of integrated circuit devices and/or circuit boards working in cooperation to accomplish the functions of a processing unit. During operation, the processor 130 executes one or more programs 140 preferably stored within the memory 132 and, as such, controls the general operation of the system 100.

The processor 130 receives and processes the above-referenced vehicle data from the from the vehicle data sources 102. The processor 130 initially compares data collected at different sources, combines and fuses the vehicle data based on syntactic similarity between various corresponding data elements of the different vehicle data, for example for use in improving products and services pertaining to the vehicles, such as future vehicle design and production. The processor 130 preferably performs these functions in accordance with the steps of process 200 described further below in connection with FIGS. 2-6. In addition, in one exemplary embodiment, the processor 130 performs these functions by executing one or more programs 140 stored in the memory 132.

The memory 132 stores the above-mentioned programs 140 and vehicle data for use by the processor 130. As denoted in FIG. 1, the term vehicle data 142 represents the vehicle data as stored in the memory 132 for use by the processor 130. The vehicle data 142 includes the various vehicle data from each of the vehicle data sources 102, for example the first data 112 from the first source 106, the second data 116 from the second source 108, the “nth” data 120 from the “nth” source 110, and so on. In addition, the memory 132 also preferably stores domain ontology 146 (preferably, critical concepts and the relations between these concepts frequently observed in data for various vehicle systems and sub-systems) and look-up tables 147 for use in determining syntactic similarity among terms in the data.

The memory 132 can be any type of suitable memory. This would include the various types of dynamic random access memory (DRAM) such as SDRAM, the various types of static RAM (SRAM), and the various types of non-volatile memory (PROM, EPROM, and flash). In certain embodiments, the memory 132 is located on and/or co-located on the same computer chip as the processor 130. It should be understood that the memory 132 may be a single type of memory component, or it may be composed of many different types of memory components. In addition, the memory 132 and the processor 130 may be distributed across several different computers that collectively comprise the system 100. For example, a portion of the memory 132 may reside on a computer within a particular apparatus or process, and another portion may reside on a remote computer off-board and away from the vehicle.

The computer bus 134 serves to transmit programs, data, status and other information or signals between the various components of the system 100. The computer bus 134 can be any suitable physical or logical means of connecting computer systems and components. This includes, but is not limited to, direct hard-wired connections, fiber optics, infrared and wireless bus technologies.

The interface 136 allows communication to the system 100, for example from a system operator or user, a remote, off-board database or processor, and/or another computer system, and can be implemented using any suitable method and apparatus. In certain embodiments, the interface 136 receives input from and provides output to a user of the system 100, for example an engineer or other employee of the vehicle manufacturer.

The storage device 138 can be any suitable type of storage apparatus, including direct access storage devices such as hard disk drives, flash systems, floppy disk drives and optical disk drives. In one exemplary embodiment, the storage device 138 is a program product including a non-transitory, computer readable storage medium from which memory 132 can receive a program 140 that executes the process 200 of FIGS. 2-6 and/or steps thereof as described in greater detail further below. Such a program product can be implemented as part of, inserted into, or otherwise coupled to the system 100. As shown in FIG. 1, in one such embodiment the storage device 138 can comprise a disk drive device that uses disks 144 to store data.

It will be appreciated that while this exemplary embodiment is described in the context of a fully functioning computer system, those skilled in the art will recognize that certain mechanisms of the present disclosure may be capable of being distributed using various computer-readable signal bearing media. Examples of computer-readable signal bearing media include: flash memory, floppy disks, hard drives, memory cards and optical disks (e.g., disk 144). It will similarly be appreciated that the system 100 may also otherwise differ from the embodiment depicted in FIG. 1, tfor example in that the system 100 may be coupled to or may otherwise utilize one or more remote, off-board computer systems.

FIG. 2 is a flow diagram of a flow path 150 for combining vehicle data, in accordance with an exemplary embodiment. In a preferred embodiment, the flow path 150 can be implemented by the system 100 of FIG. 1.

As shown in FIG. 2, the flow path 150 includes data to be augmented 151. The data to be augmented 151 comprises first vehicle data 152 from a first data source. In one embodiment, the first vehicle data 152 comprises DFMEA data, and corresponds to the first vehicle data 112 of FIG. 1. The first vehicle data 152 is provided, along with second vehicle data 154 from a second data source, to a syntactic data analysis module 156. In one embodiment, the second vehicle data 154 comprises vehicle field data, such as from a Global Analysis Reporting Tool (GART), a problem resolution tracking system (PRTS), a technical assistance center (TAC)/a customer assistance center (CAC) system, or the like, and corresponds to the second vehicle data 115 of FIG. 1. By way of background, when a fault observed in correspondence with a specific system is difficult to diagnose (e.g., as it is seen for the first time in the field, or if the service information documents do not provide necessary support to perform the root-cause investigation), in such cases technicians contact TAC where the experts provide necessary step-by-step diagnostic information to technicians. The data associated with such instances is collected in the TAC database. By way of further background, customer assistance center (CAC) refers to when customers face any issues with a vehicle either in the form of the features they are not happy about or cases in which specific features are not working, e.g. Bluetooth. In addition, domain ontology 158 (e.g., including critical concepts and the relations between these concepts frequently observed in vehicle data pertaining to a particular vehicle system or sub-system, such as power windows, and preferably corresponding to the domain ontology 146 of FIG. 1) and look-up tables 160 (preferably, corresponding to the look-up tables 147 of FIG. 1) are provided to the syntactic data analysis module 156.

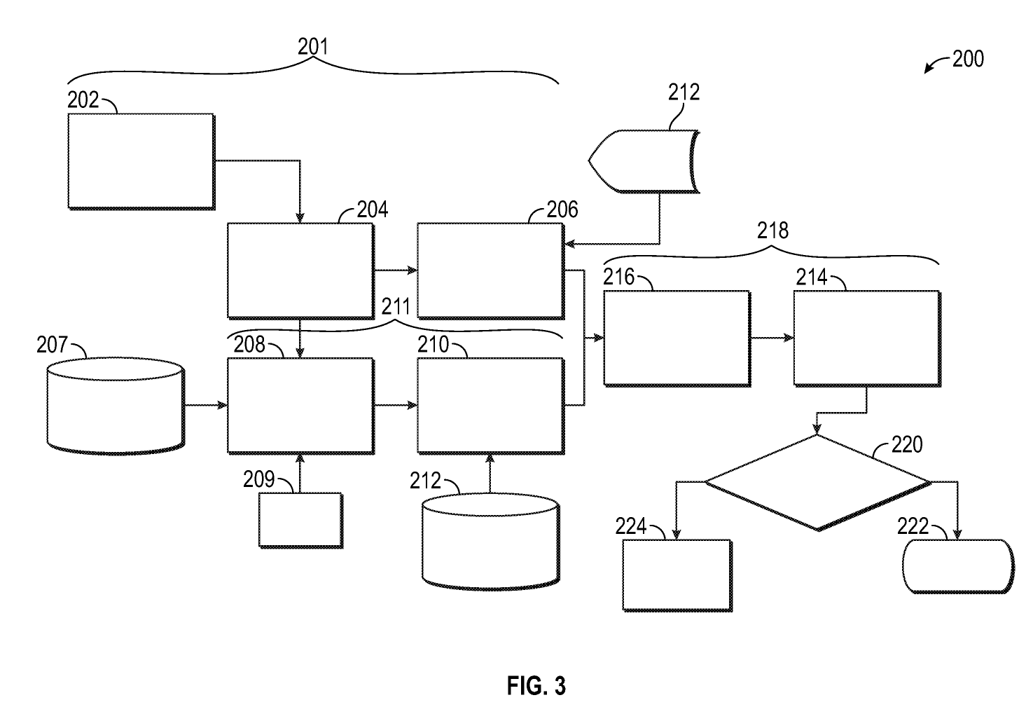

The syntactic data analysis module 156 uses the first vehicle data 152, the second vehicle data 154, the domain ontology 158, and the look-up tables 160 in collecting contextual information 162 from the first data 152 and the second data 154 and calculating a syntactic similarity 164 for elements of the first and second data 152, 154 using the contextual information 162. As explained further below in connection with FIG. 3, the syntactic similarity 164 preferably comprises a Jaccard Distance among terms. Accordingly, the syntactic data analysis module 156 is able to determine a measure of similarity between synonyms (e.g., “windows not working”, “windows will not go down”), and so on, which can then be used to augment the data to be augmented 151 (for example, by grouping synonymous terms together for analysis, and so on). The information provided via the syntactic similarity can be used to augment the data to be augmented 151, for example by grouping synonyms (i.e., terms with a high degree of syntactic similarity with one another) together for analysis, and so on.

As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality. Accordingly, in one embodiment, the syntactic data analysis module 156 comprises and/or is utilized in connection with all or a portion of the system 100, the processor 130, the memory 132, and/or the program 140 of FIG. 1. Also in one embodiment, the flow path 150 of FIG. 2 corresponds to a process 200 as depicted in FIGS. 3-7 and described below in connection therewith.

FIG. 3 is a flowchart of a process 200 for combining vehicle data, in accordance with an exemplary embodiment. In one embodiment, the process 200 comprises a methodology for in-time augmentation of DFMEA data by fusing natural language processing and statistical techniques. The process 200 corresponds to the flow path 150 of FIG. 2, and the flowchart of FIG. 3 preferably comprises a more detailed presentation of the same flow path 150 from the flow diagram of FIG. 2. In a preferred embodiment, the process 200 can be implemented by the system 100 of FIG. 1 (including the processor 130, memory 132, and program 140 thereof) and the syntactic data analysis module 156 of FIG. 2.

As depicted in FIG. 3, the process 200 includes the step of collecting first data (step 202). In one embodiment, the first data represents first data 112 from the first source 106 of FIG. 1. Also in one embodiment, the first data of step 202 comprises vehicle manufacturer via design failure mode and effects analysis (DFMEA) data. The first data is preferably obtained in step 202 by the system 100 of FIG. 1 via the first source 106 of FIG. 1, and is preferably stored in the memory 132 of the system 100 of FIG. 1 for use by the processor 130 thereof. In addition, the first data preferably corresponds to the first data 152 of FIG. 2.

Key terms are identified from the first data (step 204). The key terms preferably include references to vehicle systems, vehicle parts, failure modes, effects, and causes from the first data. The key terms are preferably identified by the processor 130 of FIG. 1.

The specific parts, failure modes, effects, and causes are then identified using the key terms, preferably by the processor 130 of FIG. 1 (step 206). The effects preferably include, for example, a particular issue or problem with a particular system or component of the vehicle (for example, front driver window is not operating correctly, and so on). The effects are preferably identified using domain ontology 212. The domain ontology is preferably stored in the memory 132 of FIG. 1 as part of the vehicle data 142. The domain ontology typically consists of critical concepts and the relations between these concepts frequently observed in the vehicle data. For example, some of the critical concepts can be System, Subsystem, Part, Failure Mode, Effects, Causes, and Repair Actions. The domain ontology also consists of instances of the critical concepts, for example, the concept Failure Mode can have instances such as Battery_Internally_Shorted, ECM_Inoperative and the like, and these instances are used by the algorithm to identify the key terms by the processor 130 of FIG. 1. The domain ontology preferably corresponds to the domain ontology 146 of FIG. 1 and the domain ontology 158 of FIG. 2. Steps 202-206 are also denoted in FIG. 3 as a combined sub-process 201.

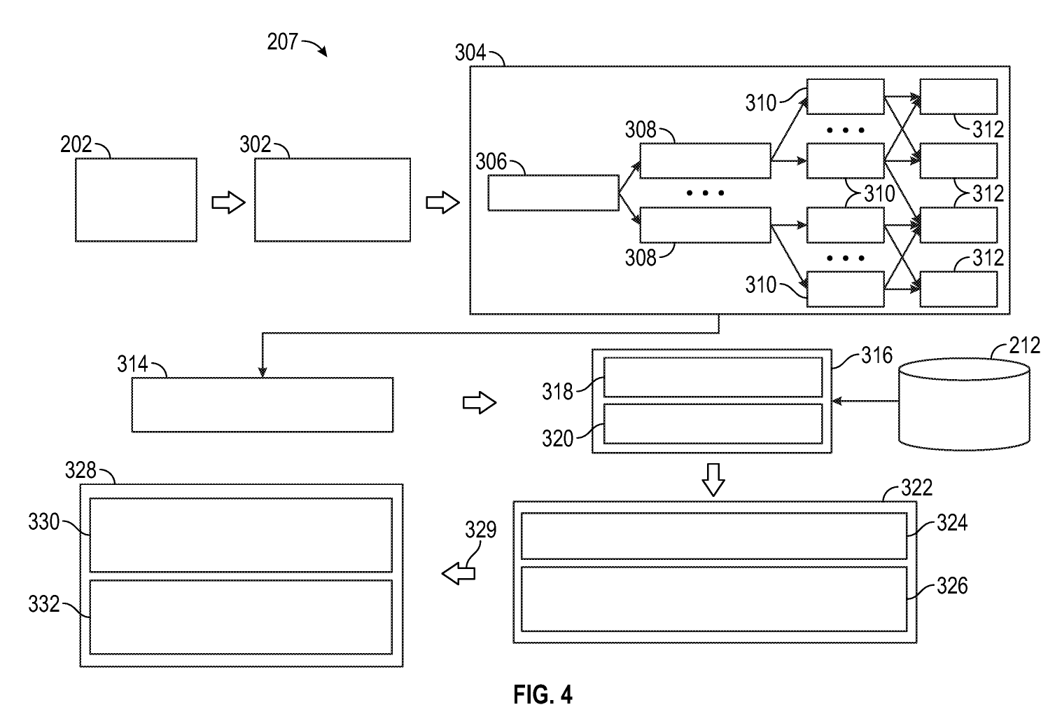

With reference to FIG. 4, a flowchart is provided for the sub-process 201 of FIG. 3, namely, classifying elements from the first data. As shown in FIG. 4, after the first data is obtained in step 202, various items, functions, failure modes, effects, and causes are extracted from the first data (step 302). This step is preferably performed by the processor 130 of FIG. 1.

Also as shown in FIG. 4, a hierarchy is generated (step 304). For each item or function 306 of the vehicle (for example, vehicle windows, vehicle engine, vehicle drive train, vehicle climate control, vehicle braking, vehicle entertainment, vehicle tires, and so on), various possible failure modes 308 are identified (e.g., window switch is not operating). For each failure mode 308, various possible effects 310 are identified (for example, window is not opening completely, window is stuck, and so on). For each effect 310, various causes 312 are identified (for example, window switch is stick, window pane is broken, and so on). Step 304 is preferably performed by the processor 130 of FIG. 1.

One of the effects is then selected for analysis (step 314), preferably by the processor 130 of FIG. 1. In one such example, an effect comprising “windows not working” is selected in a first iteration of step 314. In subsequent iterations, other effects would similarly be chosen for analysis.

For the particular chosen effect, various related identifications are made (step 316). The related identifications of step 316 are preferably made by the processor 130 of FIG. 1 using the above-mentioned domain ontology 212 from FIG. 3 for the particular effect selected in a current iteration of step 314. In the example discussed above with respect to “windows not working”, the domain ontology 212 pertaining to power windows may be used, and so on. Step 316 may be considered to comprise two related sub-steps, namely, steps 318 and 320, discussed below.

During step 318, vehicle parts are identified from the item or function associated with the selected effect in the current iteration. For example, in the case of the effect being “windows not working”, the identifications of step 318 may pertain to window switches, window panes, a power source for the window, and so, related to this effect. These identifications are preferably made by the processor 130 of FIG. 1.

During step 320, vehicle parts and symptoms are identified from failure modes, effects, and causes associated with the selected effect in the current iteration. For example, in the case of the effect being “windows not working”, the identifications of step 320 may pertain to causes, such as “power source failure”, “window switch deformation”, and so on. Corresponding effects may comprise “windows not working”, “less than optimal window performance”, and so on. Causes may include “unsuitable material”, “improper dimension”, and so on. These identifications are preferably made by the processor 130 of FIG. 1. Typically, the Item/Function string for example, “Individual Switch—Module Switch” and the effect string, for example “windows not working” consists of a part (i.e. Switch, Module Switch. Windows) and a symptom (not working) and it is necessary to identify these constructs by using the instances from the domain ontology. Having identified these constructs, they are used to select the relevant data points from the second vehicle data, such as warranty repair verbatim (language) that may include such constructs. For example, such warranty repair verbatim may be selected as the relevant data points from the second vehicle data (such as the field vehicle data) which can be used to compare, combine and fuse with the second data (e.g., the DFMEA data) to identify new failure mode, effects, and so on.

Strings are generated for the identified data elements (step 322). The strings are preferably generated by the processor 130 of FIG. 1. The strings are preferably generated using two rules, as set forth below.

In accordance with a first rule (rule 324), the string includes a part name (Pᵢ) for a vehicle part along with a symptom number (Sᵢ) for a symptom (or effect) corresponding to the vehicle part. In the above-described example, the part name (Pᵢ) may pertain, for example, to a manufacturer or industry name for a power window system (or a power window switch), while the symptom name (Sᵢ) may pertain to a manufacturer or industry name for a symptom (e.g., “not working” for the power window switch, and so on). One example of such a string in accordance with Rule 324 comprises the string “XXX XX Pᵢ XX XXX Sᵢ”, in which Pᵢ represents the part number, Sᵢ represents the symptom number, and the various “X” entries include related data (such as failure modes, effects, and causes).

In accordance with a second rule (rule 326), a determination is made to ensure that the string is not a sub-string of any longer string. For example, in the illustrative string “XSᵢ XSⱼX PᵢXX XPⱼX”, the term Pᵢ is considered to be valid but not the term Pⱼ or the term Sᵢ would be considered to be valid but not the term Sⱼ, in order to avoid redundancy.

First data output 328 is generated using the strings (step 329). The output preferably includes a first component 330 and a second component 332. The first component 330 pertains to a particular part that is identified as being associated with identified items or functions and from effects and causes for the vehicle. The first component 330 of the output may be characterized in the form of {P₁ . . . . Pᵢ}, representing various vehicle parts (for example, pertaining to the windows, in the exampled referenced above). The second component 332 pertains to a particular symptom pertaining to the identified part. The second component 332 of the output may be characterized in the form of {S₁ . . . , Sᵢ}, representing various symptoms (for example, “not working”) associated with the vehicle parts. The output is preferably generated by the processor 130 of FIG. 1. Steps 314-329 are preferably repeated for the various parts and symptoms from the first data.

Returning to FIG. 3, second data is collected (step 208). The second data preferably includes data with elements that are related to corresponding elements of the first data analyzed with respect to steps 202-206 (including the sub-process of FIG. 4), as discussed above. In one example, the second data is obtained with similar vehicle parts and symptoms as those identified in the above-described steps for the first data. In addition, the second data preferably corresponds to the second data 154 of FIG. 2.

In one embodiment, the second data represents second data 116 from the second source 108 of FIG. 1. Also in one embodiment, the second data of step 208 comprises vehicle data and the field data, for example as obtained during the early stages of vehicle design and development and vehicle maintenance and repair at various service stations at various times throughout the useful life cycle of the vehicle. In this embodiment, the system enables systematic comparison between the structured data collected during early stages of vehicle design and development, e.g. DFMEA with unstructured free flowing data that is collected in the form repair verbatim from different dealers. As discussed earlier, one of the contributions of this invention is it provides a systematic basis to compare, combine and fuse structured data with unstructured data via semantic analysis. The second data is preferably obtained in step 208 by the system 100 of FIG. 1 by the second source 108 of FIG. 1, and is preferably stored in the memory 132 of the system 100 of FIG. 1 for use by the processor 130 thereof. As denoted in FIG. 3, in certain embodiments, the second data of step 208 may be obtained using a Global Analysis Reporting Tool (GART) 207 and/or a problem resolution tracking system (PRTS) 209, which may be generated in conjunction with the various vehicle data sources 102 of FIG. 1. It will be appreciated that various additional data (for example, corresponding to the “nth” data 120 from one or more “nth” additional sources 110 of FIG. 1) may similarly be obtained (e.g. from multiple service stations and/or at multiples throughout the vehicle life cycle) and used in the same manner set forth in FIG. 3 in various iterations of the process 200.

Also as depicted in FIG. 3, the second data is classified, and symptoms are collected from the second data (step 210). As used in the context of this Application, the terms “symptom” and “effect” are intended to be synonymous with one another. The symptoms preferably include, for example, a particular issue or problem with a particular system or component of the vehicle (for example, “front driver window is not operating correctly”, and so on). The symptoms are preferably identified using the above-referenced domain ontology 212. Steps 208 and 210 are also denoted in FIG. 3 as a combined sub-process 211, discussed below.

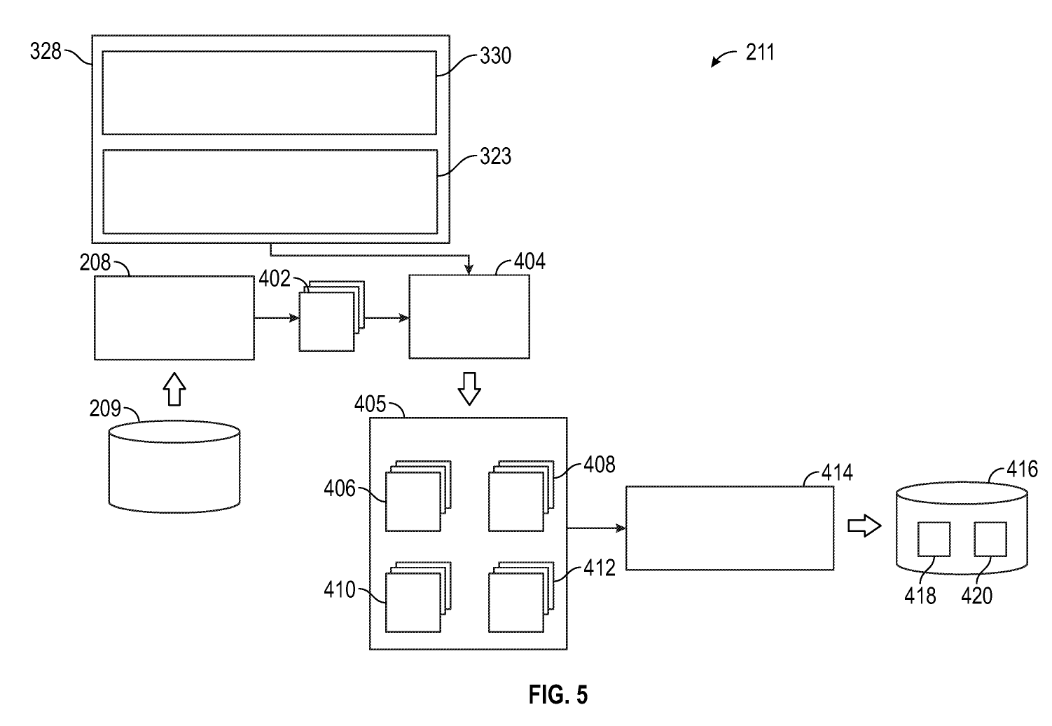

With reference to FIG. 5, a flowchart is provided for the sub-process 211 of FIG. 3, namely, classifying elements from the second data. As shown in FIG. 5, after the second data is obtained with elements pertaining to corresponding to the first data in step 208 (e.g., pertaining to the same or a similar vehicle part), technical codes are extracted from the second data to generate “verbatim data” (step 402). The verbatim data comprises the same data results as the second data in its raw form, except that notations from various entries use manufacturer or industry codes pertaining to the type of vehicle (e.g., year, make, and mode), along with the vehicle parts, symptoms, failure modes, and the like. In one embodiment, during step 402, special characters are replaced with known manufacturer or industry codes. If a string with a particular code includes a particular part identifier (Pᵢ) and is not a member of another string, then the code is collected in a category denoting that the string includes a part from the first data. Conversely, if a string with a particular code includes a particular symptom identifier (Sᵢ) and is not a member of another string, then the code is collected in a category denoting that the string includes a symptom from the first data. The term “verbatim data” can be illustrated via the following non-limiting example. When vehicle visits a dealer in case fault induced situation a technician collects the symptoms and also observe the diagnostic trouble code that are set in a vehicle. Based on this information the failure modes are identified which provide necessary engineering specific information about how a specific fault has occurred and the based on this information an appropriate corrective actions is taken to fix the problem. All of this information collected during fault diagnosis and root-cause investigation process is book kept in the form of the repair verbatim, which is typically in the form of free flowing English language. One such example of the repair verbatim is as follows—“Customer states battery is leaking and cable is corroded found negative terminal on battery leaking causing heavy corrosion on cable an replaced battery, negative cable, and R-R battery to cle”. This step is preferably performed by the processor 130 of FIG. 1.

The second data is then classified (step 404). Specifically, the second data is classified using the technical codes and the verbatim data of step 402 along with the output 328 from the analysis of the first data, (e.g., using the parts and symptoms identified in the first data to filter the second data). All such data points are preferably collected, and preferably include records of parts and symptoms from the first data, including the first component 330 and the second component 332 of the output 328 as referenced in FIG. 4 and discussed above in connection therewith. Accordingly, during step 404, the second data is classified by associating the specific codes for data elements for the verbatim data of the second data (from step 402) with potentially analogous data elements from the first data, such as pertaining to a particular vehicle part (e.g., with respect to the first data output 328). The classification is preferably performed by the processor 130 of FIG. 1.

In one embodiment, the classification of the second data results in the creation of various data entry categories 405 that include data pertaining to items or functions 406 of the vehicle (for example, vehicle windows, vehicle engine, vehicle drive train, vehicle climate control, vehicle braking, vehicle entertainment, vehicle tires, and so on), various possible failure modes 408 (e.g., window switch is not operating), effects 410 (for example, window is not opening completely, window is stuck, and so on), and causes 412 (for example, window switch is stick, window pane is broken, and so on).

A listing of vehicle symptoms is then collected from the second data (step 414). During step 414, indications of the vehicle symptoms are collected from the second data and are merged to remove duplicate symptom data elements. In one such embodiment, during step 414, if a data entry of the verbatim data for the second data includes a reference to a particular symptom (Sᵢ) that is not a member of any other string, then this symptom reference (Sᵢ) is collected. If such a particular symptom (Sᵢ) is a part of another siring, then this symptom (Sᵢ) is not collected if this other string has already been accounted for, to avoid duplication.

As a result of step 414, second data output 416 is generated using the strings. The second data output 416 preferably includes a first component 418 and a second component 420. The first component 418 pertains to a particular part that is identified in the verbatim data for the second data, and may be characterized in the form of {P₁ . . . , Pᵢ}, similar to the discussion above with respect to the first component 330 of the first data output 328. The second component 420 pertains to a particular symptom pertaining to the identified part, and may be characterized in the form of {S₁, . . . , Sᵢ}, similar to the discussion above with respect to the second component 332 of the first data output 328. The collection of the symptoms and generation of the output is preferably performed by the processor 130 of FIG. 1.

Returning to FIG. 3, contextual information is collected (step 214). The contextual information preferably pertains to the symptoms identified in the first data output 328 of FIG. 4 and the second data output 416 of FIG. 5. In one embodiment, the contextual information includes information as to vehicles, vehicle systems, parts, failure modes, and causes of the identified symptoms, as well as measures of how often the identified symptoms are typically associated with various different types of vehicles, vehicle systems, parts, failure modes, causes, and so on. The contextual information is preferably collected by the processor 130 of FIG. 1 based on the vehicle data 142 stored in the memory 132 of FIG. 1. The contextual information preferably pertains to the contextual information 162 of FIG. 2.

A semantic similarly is then calculated between respective data elements for the first data and the second data (step 216). The semantic similarity (also referred to herein as a “semantic score”) is preferably calculated using the first data output 328 (including the symptoms or effects collected in sub-process 201 for the first data) and the second data output 416 (including the symptoms or effects collected in sub-process 211). In one embodiment, the contextual information is also utilized in calculating the semantic similarity. By way of further explanation, in one embodiment the syntactic similarity is between two phrases (e.g., Effects from the DFEMA and the Symptoms from the field warranty data). Also in one embodiment, to calculate the semantic similarity the information co-occurring with these two phrases from the corpus of the field data is collected. This context information takes the form of Parts, Symptoms, and Actions associated with two phrases, and if the Parts, Symptoms and Actions co-occurring with both the phrases show high degree of overlap, then it indicates that the two phrases are in fact one and the same but written using inconsistence vocabulary. Alternatively, if the contextual information co-occurring with these two phrases show less degree of overlap, it indicates that they are not similar to each other. The semantic similarity is preferably calculated by the processor 130 of FIG. 1 based on a Jaccard Distance between respective data elements of the first data and the second data, as discussed below. Steps 214 and 216 are also denoted in FIG. 3 as a combined sub-process 218. The semantic similarity preferably corresponds to the semantic and syntactic similarity 164 of FIG. 2.

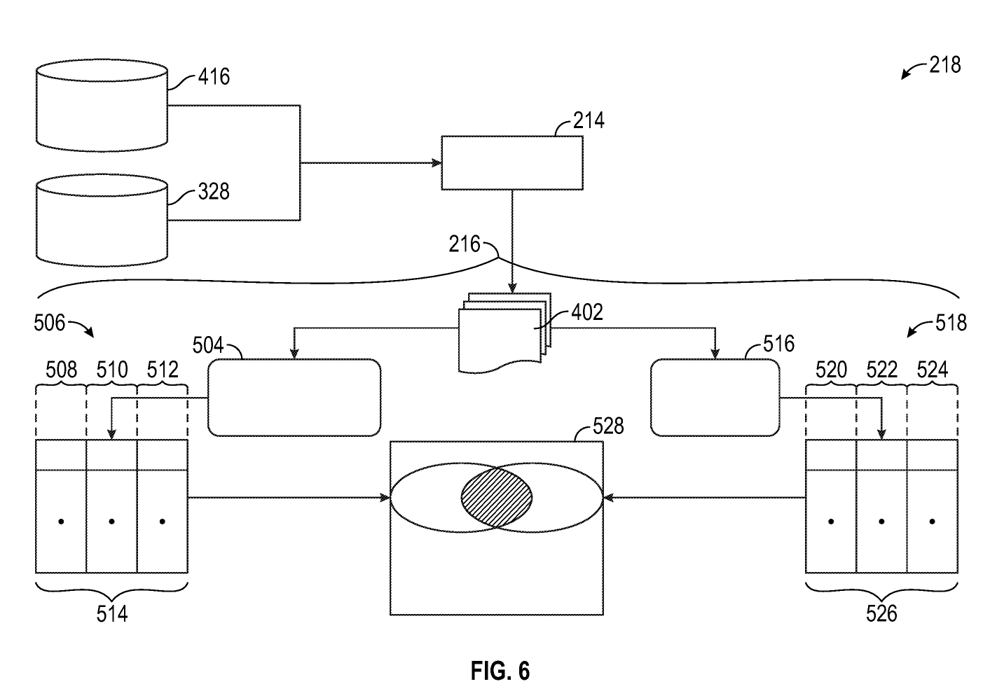

With reference to FIG. 6, a flowchart is provided for the sub-process 218 of FIG. 3, namely, determining the semantic similarity. As shown in FIG. 6, the first data output 328, the second data output 416, and the contextual information of step 214 are used are used together with the verbatim data of the second data of step 402 of FIG. 5 to determine the syntactic similarity.

In step 504, the verbatim data of the second data of step 402 is filtered with the second data output 416. Step 504 is preferably performed by the processor 130 of FIG. 1, and results in a first matrix 506 of values. As depicted in FIG. 6, the first matrix 506 includes its own vehicle part values (P₁, P₂, . . . Pᵢ) 508, vehicle symptom values (S₁, S₂, . . . Sₘ) 510, and vehicle action values (A₁, A₂ . . . Aₙ) 512, along with a first co-occurring phrase set 514. While filtering out the repair verbatim or any second data, preferably only data points are selected that consists of records of the symptoms which are occurring on their own as an individual phrase without being a member of any longer phrase.

In step 516, the verbatim data of the second data of step 402 is filtered with the first data output 328, Step 516 is preferably performed by the processor 130 of FIG. 1, and results in a second matrix 518 of values. As depicted in FIG. 6, the second matrix 518 includes various vehicle part values (P₁, P₂, . . . Pᵢ) 520, vehicle symptom values (S₁, S₂, . . . Sₘ) 522, and vehicle action values (A₁, A₂, . . . Aₙ) 524, along with a second co-occurring phrase set 526.

A Jaccard Distance is calculated between the first and second matrices 506, 518 (step 528). In a preferred embodiment, the Jaccard Distance is calculated by the processor 130 of FIG. 1 in accordance with the following equation:

$$\begin{matrix}Jaccard Distance = \frac{{S}_{1} ⋂ {S}_{2}}{{S}_{1} ⋃ {S}_{2}} ,\end{matrix} \qquad ( Equation 1 )$$

in which S₁ represents the first co-occurring phrase set 514 of the first matrix 506 and S₂ represents the second co-occurring phrase set 526 of the second matrix 518. Typically S₁ consists of phrases, such as parts, symptoms and actions co-occurring with Symptom from the field data whereas S₂ consists of phrases such as parts, symptoms, and action co-occurring with Effect from DFMEA. The phrase co-occurrence is preferably identified by applying a word window of four words on the either side. For example, if a verbatim consists of a particular Symptom, then the various phrases that are recorded for the Symptom in a verbatim are collected. From the collected phrases, symptoms and actions pertaining to this Symptom are collected to construct S₁. The same process is applied to construct S₂ from all such repair verbatim corresponding to a particular Effect. The process is then repeated for each of the Symptoms and Effects in the data. Accordingly, by taking the intersection of the first and second co-occurring phrases 514, 526 and dividing this value by the union of the first and second co-occurring phrases 514, 526, the Jaccard Distance takes into account the overlap of the co-occurring phrases 514, 526 as compared with the overall frequency of such phrases in the data.

Returning to FIG. 3, a determination is made as to whether the semantic similarity is greater than a predetermined threshold (step 220). The predetermined threshold is preferably retrieved from the look-up table 147 of FIG. 1, preferably also corresponding to the look-up tables 160 of FIG. 2. Similar to the discussion above, the semantic similarity used in this determination preferably comprises the Jaccard Distance between the first and second co-occurring phrases 514, 526 of FIG. 6, as discussed above in connection with step 528 of FIG. 6. In one embodiment, the predetermined threshold is equal to 0.5; however, this may vary in other embodiments. The determination of step 220 is preferably made by the processor 130 of FIG. 1.

If the semantic similarity is greater than the predetermined threshold, then the first and second co-occurring phrases are determined to be related, and are preferably determined to be synonymous, with one another (step 222). Conversely, if the semantic similarity is less than the predetermined threshold, then the first and second co-occurring phrases are not considered to be synonymous, but are used as new information pertaining to the vehicles (step 224). In one embodiment, all such phrases with Jaccard Distance score is less than 0.5 are treated as the ones which are not presently recorded in the DFMEA data, whereas all such phrases with Jaccard Distance score greater than 0.5 are treated as the synonymous of Effect from the DFMEA.

In either case, the results can be used for effectively combining data from various sources (e.g. the first and second data), and can subsequently be used for further development and improvement of the vehicles and products and services pertaining thereto. For example, the information provided via the semantic similarity can be used to augment or otherwise improve data (such as the data to be augmented 151 of FIG. 2, preferably corresponding to the DFMEA data), for example by grouping synonyms (i.e., terms with a high degree of semantic similarity with one another) together for analysis, and so on. The determinations of steps 222 and 224 and the implementation thereof are preferably made by the processor 130 of FIG. 1.

For example, in one such embodiment, the process 300 helps to bridge the gap between successive model years for a particular vehicle model. Typically DFMEA data is developed during early stages of vehicle development. Subsequently, large amount of data is collected in the field either from the existing fleet, or whenever new version of the existing vehicle is designed. This may also reveal new Failure Modes, Effects, Causes that can be observed in the field data. Typically, given the size of the data that is collected in the field, it would not generally be possible to manually compare and contrast the new data with the DFMEA data to augment old DFMEA's in-time and periodically. However, the techniques disclosed in this Application (including the process 300 and the corresponding system 100 of FIG. 1 and flow path 150 of FIG. 2) allows for the automatic comparison of the data associated with existing vehicle fleet or the one coming from new release of the existing vehicle, and suggest new Failure Modes, Effects, Causes which are not there in the existing DFMEAs which need to be augmented in them to make the future releases more and more fault free and robust.

Table 1 below shows exemplary semantic similarity results from step 220 of the process 200 of FIG. 3, in accordance with one exemplary embodiment.

TABLE 1

| | New Information | | Semantic |
|---|---|---|---|
| DFMEA Effect | for Parts | Synonyms | Similarity Value |
| Windows not | INDIVIDUAL | WILL NOT GO | 1 |
| Working | SWITCH | DOWN | |
| | W/L SWITCH, | WOULD NOT | 0.9705 |
| | INDIVIDUAL | WORK | |
| | SWITCH | | |
| | MODULE | OPERATION | 0.5625 |
| | SWITCH | PROBLEM | |
| Bad performance | BUTTON (W/L) | WILL NOT GO | 1 |
| | PLUNGER (Auto), | DOWN | |
| | BUTTON (Auto), | | |
| | BOX (2P), | | |
| | INDIVIDUAL | WOULD NOT | 0.6206896551724138 |
| | SWITCH | WORK | |
| | W/L SWITCH, | | |
| | INDIVIDUAL | INTERNAL FAIL | 0.7 |
| | SWITCH | | |
| | MODULE | | |
| | SWITCH, | | |
| | SWITCH | DAMAGED | 0.9655172413793104 |
| | ASSEMPLY | | |
| | POWER WINDOW | | |
| | (BOX ASSEMBLY) | | |

| | New Information | | Semantic |
|---|---|---|---|
| DFMEA Effect | for Parts | New Information | Similarity Value |
| Windows not | INDIVIDUAL SWITCH | NOT LOCKED IN ALL | 0.2058 |
| Working | | THE WAY | |
| | W/L SWITCH, | WON'T GO ALL THE | 0.21875 |
| | INDIVIDUAL SWITCH | WAY | |
| | MODULE SWITCH | WON'T ROLL UP | 0.44117 |
| | | NOT UNLOCKING | 0.46875 |
| | | IS NOT TURNING | 0.46875 |
| | | ON | |
| Bad | BUTTON (W/L) | INOPERATIVE | 0.3448 |
| performance | PLUNGER (Auto), | | |
| | BUTTON (Auto), | HAS DELAY | 0.42068 |
| | BOX (2P), | | |
| | INDIVIDUAL SWITCH | LOOSE | 0.5172 |
| | W/L SWITCH, | CONNECTION | |
| | INDIVIDUAL SWITCH | NOTE OPERATE | |
| | MODULE SWITCH, | | |
| | SWITCH ASSEMPLY | | |
| | POWER WINDOW | | |
| | (BOX ASSEMBLY) | | |

In the exemplary embodiment of TABLE 1, semantic similarity is determined in an application using multiple data sources (namely, DFMEA data and field data) pertaining to the functioning of vehicle windows. Also in the embodiment of TABLE 1, the predetermined threshold for the syntactic similarity (i.e., for the Jaccard Distance) is equal to 0.5.

As shown in TABLE 1, the phrase “windows not working” is considered to be synonymous with respect to the terms “will not go down” (with a perfect semantic similarity score of 1.0), “would not work” (with a near-perfect semantic score of 0.9705), and “operation problem” (with a semantic score of 0.5625 that is still above the predetermined threshold), as used for certain window related references. However, the phrase “windows not working” is considered to be not synonymous with respect to the terms “not locked all the way” (with a semantic similarity score of 0.2058), “won't go all the way” (with a semantic score of 0.21875), “won't roll up” (with a semantic score of 0.44117), “not unlocking” (with a semantic score of 0.46875), and “is not turning on” (also with a semantic score of 0.46875), as used for certain window related references (namely, because each of these semantic scores are less than the predetermined threshold in this example).

Also as shown in TABLE 1, the phrase “bad performance” is considered to be synonymous with respect to the terms “will not go down” (with a perfect semantic similarity score of 1.0), “would not work” (with a near-perfect semantic score of 0.62069), “internal fail” (with a semantic score of 0.7 that is above the predetermined threshold). “damaged” (with a semantic score of 0.96552 that is above the predetermined threshold), and “loose connection” (with a semantic score of 0.5172, that is still above the exemplary threshold of 0.5), as used for certain window related references. However, the phrase “bad performance” is considered to be not synonymous with respect to the terms “inoperative” (with a semantic similarity score of 0.3448), “has delay” (with a semantic score of 0.42068), and “not operate” (with a semantic score of 0.34615), as used for certain window related references (namely, because each of these semantic scores are less than the predetermined threshold in this example). In addition, Applicant notes that the terms appearing under the heading “New Information for Parts” in TABLE 1 are terms identified from DFMEA documentation. For example, the terms “windows not working” has a score of 0.2058 with respect to “not locked in all the way”, as well as for “module switch locked in all the way.”

It will be appreciated that the disclosed systems and processes may differ from those depicted in the Figures and/or described above. For example, the system 100, the sources 102, and/or various parts and/or components thereof may differ from those of FIG. 1 and/or described above. Similarly, certain steps of the process 200 may be unnecessary and/or may vary from those depicted in FIGS. 2-6 and described above. In addition, while two types of data (from two data sources) are illustrated in FIGS. 2-6, it will be appreciated that the same techniques can be utilized in combining any number of types of data (from any number of data sources). It will similarly be appreciated that various steps of the process 200 may occur simultaneously or in an order that is otherwise different from that depicted in FIGS. 2-6 and/or described above. It will similarly be appreciated that, while the disclosed methods and systems are described above as being used in connection with automobiles such as sedans, trucks, vans, and sports utility vehicles, the disclosed methods and systems may also be used in connection with any number of different types of vehicles, and in connection with any number of different systems thereof and environments pertaining thereto.

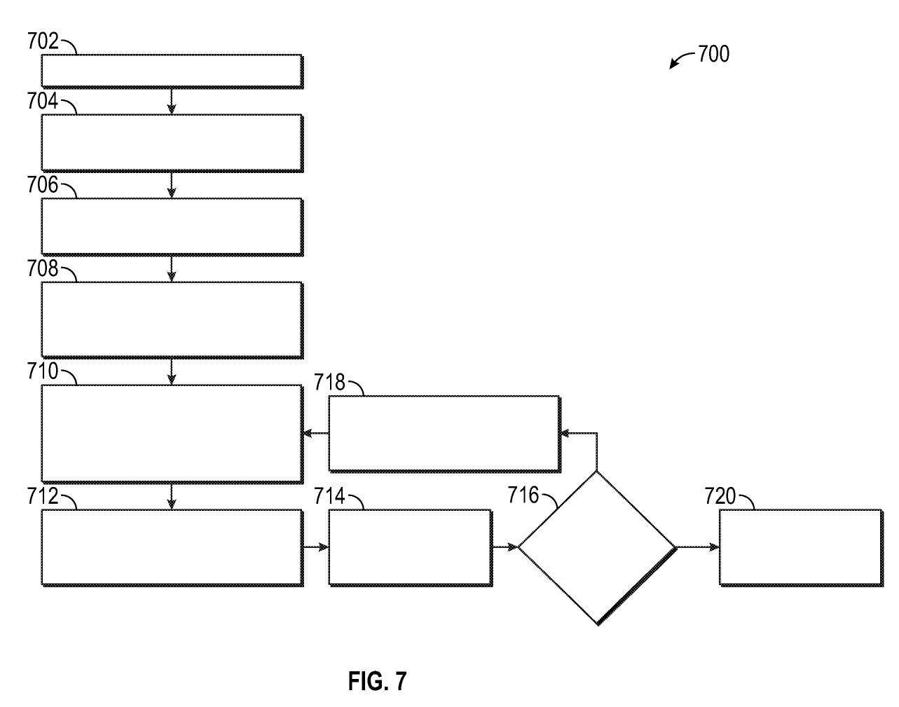

FIG. 7 is a flowchart of a sub-process 700 for disambiguation of abbreviated terms, in accordance with an exemplary embodiment. In accordance with one embodiment, during the sub-process 700 of FIG. 7, the two sources (e.g. the first data source 106 and the second data source 108) are compared with each other by using the semantic similarity model.

In one embodiment, the sub-process 700 of FIG. 7 supplements combined step 218 (including steps 214 and 216) of FIGS. 3 and 6, described above. Also in one embodiment, the sub-process 700 of FIG. 7 is implemented via the processor 130 of FIG. 1, in accordance with the syntactic data analysis module 156 of FIG. 2.

In one embodiment, the context information from these data sources must be relevant to the system, modules, and functions of the vehicle, with each other to make sure correct system information is compared with each other. Also in one embodiment, while collecting the context information in some cases, the terms that appear as context information (e.g. in the word window) are abbreviated entries. In addition, in one embodiment, all such abbreviated entries are disambiguated to assess whether they are associated with the relevant system.

For example, in accordance with one embodiment, suppose that a system is comparing the DFMEA and warranty data for a Tank Pressure Sensor Module. Further suppose that the system observes certain abbreviated terms, e.g. “TPS”, and in the domain. In certain examples, this abbreviation may belong to ‘Tank Pressure Sensor’ or ‘Tire Pressure Sensor’, among other possible meanings. In one embodiment, if the context information from the warranty data related to abbreviation that represents ‘Tire Pressure Sensor, while data referring to ‘Tank Pressure Sensor’ is collected with respect to the DFMEA data, then the algorithm could potentially otherwise end up comparing wrong data elements and constructs. In order to handle such a possible issue, the model uses the following algorithm, described further below, for handling the abbreviated entries to make sure that correct context information is being collected.

As depicted in FIG. 7, the process 700 begins at 702. In various embodiments, the various steps of the process 700 are performed by the processor 130 of FIG. 1.

The abbreviations, “Abbᵢ”, are identified and disambiguated at 704. In various embodiments, no predefined dictionary of abbreviations is used, and instead their full forms are disambiguated.

In various embodiments, abbreviations are identified for each term in the database. For example, in various embodiments, data from a data corpus (e.g., a corpus of repair data) is used to generate a corpus with abbreviations (e.g., Abb₁, Abb₂, . . . , Abbₙ). In various embodiments, the abbreviations are identified by matching them with the abbreviations derived from the domain specific documents. Also in various embodiments, the corpus of abbreviations includes an abbreviation that is identified for each specific term in the database.

Also in various embodiments, contextual information is utilized in conjunction with the corpus with abbreviations. For example, in certain embodiments, the context information is in the form of embedding from the same verbatim such as critical parts, symptoms (text or diagnostic trouble code), failure modes or the action terms are collected. In certain embodiments, the contextual information is utilized with the corpus of all forms in order to generate baseline data that in order to generate baseword pairs. In one embodiment, for each text data point, the word window (e.g., a word window of three words, in one embodiment—although the number of words may vary in other embodiments) is set on the either side of the baseline term Bᵢ to collect the context information, i.e. the parts, symptoms (textual and diagnostic trouble codes), and actions co-occurring with Bᵢ and the following tuples are constructed—(Bⱼ Pᵢ) (Bⱼ Sᵢ) and (Bᵢ Aⱼ), where Parts. Pₐ={P₁, P₂, . . . , Pᵢ)}, Symptoms, S_{b}={S₁, S₂, . . . , Sⱼ} and Actions, A_{b}={A₁, A₂, . . . , Aₖ}, for example in accordance with the following:

(B₁ P₁), (B₂ P₂), . . . , (Bᵢ Pⱼ)
(B₁ S₁), (B₂ S₂), . . . . , (Bⱼ Pₖ)
(B₁ A₁), (B₂ A₂), . . . , (Bₖ Aₘ)

Also in various embodiments, an identification is made at 706 as to relevant data comprising full form terms. In certain embodiments, full data entries from each term in the database are used. For example, in various embodiments, data from the data corpus (e.g., the corpus of repair data) is used to generate a corpus with all forms that includes various basewords (e.g., B₁, B₂, . . . , Bₙ) for the terms. In various embodiments, the corpus of all forms 804 includes a full form term, or baseword, for each specific term in the database. Also in various embodiments, contextual information is utilized in conjunction with the corpus with all forms.

Also in certain embodiments, the contextual information is also utilized with the corpus with abbreviations in order to generate abbreviation data that in order to generate abbreviation pairs. In one embodiment, for each text data point, the word window (e.g., a word window of three words, in one embodiment—although the number of words may vary in other embodiments) is set on the either side of the abbreviation term Abbᵢ to collect the context information, i.e. the parts, symptoms (textual and diagnostic trouble codes), and actions co-occurring with Abbᵢ and the following tuples are constructed—(Abb₁ Pᵢ) (Abbⱼ Sᵢ) and (Abbᵢ Aⱼ), where Parts, Pₐ={P₁, P₂, . . . , Pⱼ}, Symptoms, S_{b}={S₁, S₂, . . . , Sⱼ} and Actions, A_{b}=(A₁, A₂, . . . , Aₖ), for example in accordance with the following:

(Abb₁ P₁), (Abb₂ P₂), . . . , (Abbᵢ Pᵢ)
(Abb₁ S₁), (Abb₂ S₂), . . . , (Abbⱼ Pⱼ) (Abb₁ A₁), (Abb₂ A₂), . . . , (Abbₖ Aₖ)

Also in certain embodiments, filtering is performed as part of 704 and 706. In one embodiment, filtering is performed of the record of the basewords, and then the word window of three words is applied on the either side of baseword. In one embodiment, the parts, symptoms and actions co-occurring with the basewords are collected and the following tuples are constructed—{Bₙ Pₐ}, {Bₙ S_{b}} and {Bₙ A_{c}}, where Parts, Pₐ={P₁, P₂, . . . , Pᵢ}, Symptoms, S_{b}={S₁, S₂, . . . . Sⱼ) and Actions, A_{b}=(A₁, A₂, . . . , Aₖ}.

In various embodiments, first-order co-occurring terms are collected at 708 with respect to each instance of a full form term. For example, in certain embodiments, if we are comparing two terms, such as engine control module and powertrain control module, then the critical terms that are mentioned in the same documents in which these two terms are mentioned such as engine misfire, vehicle stalling, bad battery, P0110, leak, internal short, and so on are collected.

In various embodiments, a set intersection is performed at 710, for example in order to ascertain common Parts, Symptoms, and Actions that are co-occurring with respect to different full form terms. In various embodiments, a set of intersection as shown in Equations (2)-(4) below is taken to identify the common parts, symptoms, and actions co-occurring with Abbᵢ and Bₙ in order to facilitate the meaningful estimation of probabilities.

Pₛ=P₁∩Pᵢ= (Equation 2)

Sₙ=Sₖ∩Sⱼ (Equation 3)

Aᵣ=Aₙ∩Aₖ (Equation 4)

Also in various embodiments, for the common set of parts. Pᵢ, symptoms, Sₙ and actions, A_{f}, the posterior probabilities, PBnPi, PBnSn, and PBnAf are estimated by using Naïve Bayes techniques. Also in one embodiment, due to the space limitation through Equations (5)-(10), it is shown how the posterior probability of PBₙSₙ is calculated and the posterior probability calculations of PBₙPᵢ and PBₙA_{f} can be realized in a similar manner.

$$\begin{matrix}{B}_{k} = arg {B}_{n} max P ( {B}_{n} \vert {S}_{n} ) & ( Equation 5 ) \\ = arg {B}_{n} max {PS}_{n} {B}_{n} P ( {B}_{n} ) P ( {S}_{n} ) & ( Equation 6 ) \\ = arg {B}_{n} max {PS}_{n} {B}_{n} P ( {B}_{n} ) & ( Equation 7 )\end{matrix}$$

Also in one embodiment, the logarithms are calculated in Equation (8) below as follows:

Bₖ=argBₙmax log PSₙBₙ+log P(Bₙ) (Equation 8)

The posterior probabilities are estimated at 712. In one embodiment, the posterior probabilities are represented by the following:

P(Bₙ|Pₛ)
P(Bₙ|Sₙ)
P(Bₙ|A_{f})

In addition, in various embodiments, the symptoms and actions co-occurring with Bₙ make up our context C and the Naïve Bayes assumption is made that symptoms and actions are independent of each other, as set forth in Equation (9) below:

P(C|Bₙ)P=Sₙ|Sₙ in C|Bₙ=SₙεCP(Sₙ|Bₙ) (Equation 9)

Also in one embodiment, the PSₙBₙ in Equation (8) and the PBₙ in Equation (9) are calculated using Equation (10) below:

P(Sₙ|Bₙ)=f(Sₙ,Bₙ)f(Bₙ) and P(Bₙ)=f(S_{n′},Bₙ)f(S_{n′}) (Equation 10)

### Wherein:

f(Sₙ, Bₙ) and f(S_{n′}. Bₙ)=Number of co-occurrences of Sₙ and S_{n′} with the basewordBn respectively; and

f(Sn′)=Occurrences of other symptoms S_{n′} out of the word window with respect to the baseword Bₙ in a corpus.

The maximum likelihood of each symptom is calculated at 714. In one embodiment, the maximum likelihood of each symptom in S is calculated for P(Bₙ) and PSₙBₙ and the baseword with maximum PBₙPᵢ,PBₙSₙ, and PBₙA_{f}, is selected as the correct meaning of Abbᵢ. Also in one embodiment, the maximum likelihood, P(Sₙ|Bₙ) and P(Bₙ) are estimated from the corpus using the following equation:

Bₖ=argBₙmax[Σ_{(SnεC)}log P(S_{n|}Bₙ₎+log P(Bₙ)] (Equation 11)

Also in one embodiment, having disambiguated the meaning of an abbreviation if it is relevant for the system/module/function for which the comparison is performed, then the context information around such disambiguated abbreviation is collected as part of 714.

A determination is made at 716 as to whether the probabilities are of 712 and/or 714 are discriminative. In other words, in certain embodiments, after computing the conditional probabilities of the context information, and it is not possible to disambiguate the term meanings, then the second order co-occurring terms are collected (e.g., because it may be difficult or impossible to disambiguate the abbreviations due to sparse co-occurring context information).

If it is determined at 716 that the probabilities are not discriminative, then second-order co-occurring terms are collected at 718 with respect to each instance of a full form term (for example, similar to 708 above, but using second-order co-occurring terms). That is, in certain embodiments, the context terms that are co-occurring during first order co-occurrence are collected, and then iteratively their contextual information is also collected. For example, if during first order co-occurrence we collect two set of context information, S1={t₁, t₂, t₃, . . . , tᵢ} and S2=(t₁₁, t₁₂, t₁₃, . . . , tⱼ), then for each tₘεS1 and tₙ εS2 their c-occurring terms are collected. Next, the joint probabilities of these second order co-occurring terms are computed with respect to each term in S1 and S2. The resulting probabilities are used to determine the final result, in one embodiment. The process then returns to 710 in a new iteration.

Conversely, if it is determined at 716 that the probabilities are discriminative, then the abbreviation is instead established as having the same meaning as the full form term. In certain embodiments, the process then terminates.

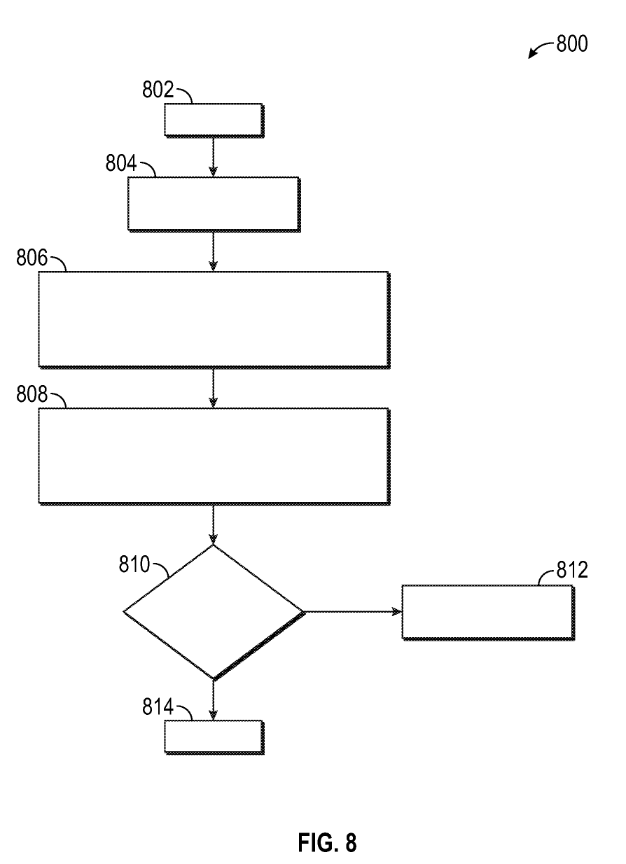

FIG. 8 is a flowchart of a sub-process 800 for analyzing DFMEA data, in accordance with an exemplary embodiment. In accordance with one embodiment, having compared the DFMEA with the Warranty data by using the semantic similarity engine if there are symptoms or failure modes are discovered by the algorithm (e.g. as described earlier), the method (and accompanying system) further checks for repeat visit cases and then updates the DFMEA accordingly, as described in greater detail below.

In one embodiment, the sub-process 800 of FIG. 8 supplements combined steps 207 (including steps 202, 204, and 206) and 211 (including steps 208 and 210) of FIGS. 3, 4, and 5, respectively, described above. Moreover, the proposed approach also takes into non-textual data to identify the repeat visit cases, that comes in the forms of diagnostic trouble codes (DTCs) and labor codes observed and used in each visit of a vehicle made at the dealership and then employs association rule mining approach to identify the significant repeat visit cases. To explain in more detail, when a vehicle, say Vᵢ makes a visit to the dealership then DTCs, say DTCⱼ=(DTC₁, DTC₂, DTC₃, . . . , DTCₘ) observed in the first visit along with text symptoms are collected. If the same vehicle, i.e. Vᵢ comes back to the dealership within 45-60 days time from the first visit, then the DTCs, say DTCⱼ=(DTC₁, DTC₂, DTC₃, . . . , DTCₙ) and text symptoms are again collected in the second visit. The DTCᵢ and DTCⱼ along with the text symptoms observed in both the visits are compared with each other to identify common DTCs or text symptoms. Then the labor codes, i.e. the repair actions performed by technicians in first and any of the subsequent visit performed to fix the overlapping symptoms are also collected, say S1=(L₁¹, L₂¹, L₃¹, . . . Lₚ¹) be the set of labor codes (repairs) used during the first visit of vehicle Vⱼ and S2=(L₁², L₂², L₃², . . . L_{q}²) be the set of labor codes (repairs) used during the second visit of vehicle Vᵢ. We take the Cartesian product of the two sets, S1 and S2 to obtain possible associations between the repairs that are performed during the first and the second visit of vehicle Vᵢ. That is, Set of possible associations, C={L₁¹, L₁²}, {L₁¹, L₂²}, . . . {Lₚ¹, L_{q}²}. Aggregation of such associations for all the vehicles within a specific period of time (i.e. 45-60 days) allows us to highlight major repairs, say {Lₚ¹, L_{q}²} that are contributing to repeat visits to dealers. At any given time, there are thousands of vehicles on the road and it is crucial to find whether any specific {DTC-LC} patterns used in the first visit and the second visit (or any subsequent visit) are appearing more frequently than the norm. The use of association rule mining correctly identifies the {DTC-LC} patterns that are hidden in the millions of claims submitted from the field data. At the same time, it also identifies the anomaly cases which are infrequent in the identified {DTC-LC} patterns and hence they are difficult to discover. In many cases, our algorithm generates large number of {DTC-LC} patterns, which makes it difficult for the end users to comprehend. To this end, the algorithm makes use of the notion of confidence to establish the relevance between DTCs and LCs. The value of confidence is a probability of observing a particular LC for given DTCs. This probability is in the range of 0-1, where 1 states that a specific LC is used for all the occurrences of given DTCs.

$$\begin{matrix}Confidence = ( {LC}_{1} , {DTC}_{1} , {DTC}_{2} ) \\ = Prob ( {LC}_{1} \vert {DTC}_{1} , {DTC}_{2} ) \\ = N ( {LC}_{1} , {DTC}_{1} , {DTC}_{2} ) / N ( {DTC}_{1} , {DTC}_{2} )\end{matrix}$$

where,
_{N}(LC₁, DTC₁, DTC₂)=total number of cases from Vᵢ (1) involving labor code LC₁ and diagnostic trouble codes DTC₁ and DTC₂;
   _{N}(DTC₁, DTC₂)=total number of cases from Vᵢ involving diagnostic trouble codes, DTC₁ and DTC₂. The same process that is used to identify the DTC symptoms in repeat visits is used for identifying the textual symptoms. The common symptoms and their related failure modes, then compared with the ones that are captured in the DFMEA data using the syntactic and semantic similarity. Also in one embodiment, the sub-process 800 of FIG. 8 is implemented via the processor 130 of FIG. 1, in accordance with the syntactic data analysis module 156 of FIG. 2.

As depicted in FIG. 8, in one embodiment, the process 800 begins at 802. In various embodiments, the various steps of the process 800 are performed by the processor 130 of FIG. 1.

An identification is made at 804 of any repeat visit cases. In certain embodiments, the identification is made using a rule that, if the same vehicle visits a dealership in less than a predetermined amount of time (e.g., forty days in one embodiment, or sixty days in another embodiment—they amount of time may vary in different embodiments), then such vehicles are considered to represent repeat visits. In certain embodiments, a repeat visit comprises such a return of the vehicle to the dealership within the predetermine amount of time for the same and/or similar symptoms.

Various data is collected at 806 with respect to the repeat visit cases. Specifically, in various embodiments, the text symptoms and non-text symptoms (e.g., a diagnostic trouble code) are both collected and observed in repeat visits of the vehicle, along with their related failure modes. In certain embodiments, the data is collected for the repeat use cases with respect to the Symptoms, (S1, S2, . . . , Si), Failure Modes, (FM1, FM2, . . . FMj), and combinations thereof (S1 FM1, S1 FM2, S2 FM1, S2 FM2, . . . Si FMj).

A semantic and syntactic similarity are determined at 808 with respect to symptoms and failure modes in repeat visits with the corresponding terms mentioned in the DFMEA data.

Specifically, in one embodiment, the critical terms (single word or multiple word phrases) are identified by using one of the following two ways, as set forth below.

First, when the domain knowledge is available in the form of domain ontology, it is used to tag the critical terms, such as Parts, Symptoms, Failure Modes from the documents. However, once the critical terms are identified we identify the embedding of the identified critical terms from the corpus.

Second, in the absence of domain knowledge, that is if the domain ontology is unavailable in that case, we identify the syntactic part of speech (POS) tags associated with the critical terms. That is, the N grams¹ are constructed from the data, and the POS tags of the Part terms, Symptom terms, Failure Mode terms are identified. These POS tags then used to compute the syntactic similarity score between the DFMEA and the warranty data documents. This is a major difference between our approach and the approach proposed by Mizuguchi and other approaches, which allows us to compute the similarity between the two documents even when the domain knowledge is not available.

Tables 2, 3, 4, and 5 below show the part of speech tags identified of the part terms, symptom terms, failure mode terms, and the action terms.

TABLE 2
The part of speech tags of the Part terms identified
from the corpus used to compute the syntactic similarity
when the domain ontology is unavailable.

| Ngram | NGramType | NGramName |
|---|---|---|
| CD | 1 | P |
| M | 1 | P |
| NNPS | 1 | P |
| NN | 1 | P |
| C | 1 | P |
| JJ | 1 | P |
| VBN | 1 | P |
| NNP | 1 | P |
| VBG | 1 | P |
| NNS | 1 | P |
| P | 1 | P |
| VB | 1 | P |
| O | 1 | P |
| VB NN | 2 | P |
| NN SYM | 2 | P |
| DT NN | 2 | P |
| NNP VBG | 2 | P |
| VBG NNS | 2 | P |
| NNS VBP | 2 | P |
| NNP CD | 2 | P |
| NN CD | 2 | P |
| NN NNP | 2 | P |
| VB NNS | 2 | P |
| JJ NN | 2 | P |
| CD NNS | 2 | P |
| CD NNP | 2 | P |
| FUNCTIONAL NNP | 2 | P |
| NNP NN | 2 | P |
| JJ NNP | 2 | P |
| JJ NNS | 2 | P |
| NNP NNS | 2 | P |
| VB NNP | 2 | P |
| VBG JJ | 2 | P |
| NN NN | 2 | P |
| IN NNP | 2 | P |
| NN VBD | 2 | P |
| RB NN | 2 | P |
| RB NNS | 2 | P |
| NNP NNP | 2 | P |
| RP NN | 2 | P |
| VBG NN | 2 | P |
| NEUTRAL NNP | 2 | P |
| JJ NNPS | 2 | P |
| NN VB | 2 | P |
| IN NN | 2 | P |
| SIDE NNP | 2 | P |
| NN NNS | 2 | P |
| CD NN | 2 | P |
| NNP VBZ | 2 | P |
| VBN NN | 2 | P |
| NNP NNP NNP | 3 | P |
| NNS VBP NN | 3 | P |
| NNS NNP NN | 3 | P |
| CD IN NN | 3 | P |
| NN IN NNP | 3 | P |
| NNP # CD | 3 | P |
| IN NNP NN | 3 | P |
| VB IN NNP | 3 | P |
| CD NNP NNS | 3 | P |
| VB NN NNS | 3 | P |
| JJ NNP NN | 3 | P |
| JJ NNP NNP | 3 | P |
| NEUTRAL NNP NNP | 3 | P |
| VBG VBG NN | 3 | P |
| NNP IN NNP | 3 | P |
| NN NN [symbol] | 3 | P |
| JJ VBG NN | 3 | P |
| NN IN NN | 3 | P |
| JJ NNS VBP | 3 | P |
| IN DT NN | 3 | P |
| NNS NN NN | 3 | P |
| IN NNP NNP | 3 | P |
| RB NNP NN | 3 | P |
| VBZ RP NN | 3 | P |
| NNP NNP NN | 3 | P |
| VBG NN NN | 3 | P |
| VB NNP NNP | 3 | P |
| VB NN NN | 3 | P |
| IN NN NN | 3 | P |
| NNS IN NNS | 3 | P |
| NNS CC NN | 3 | P |
| NN NN VBP | 3 | P |
| NNP NNP VBD | 3 | P |
| NN JJ NN | 3 | P |
| VB NNP NNS | 3 | P |
| VBG NN NNS | 3 | P |
| JJ NNS NNS | 3 | P |
| NN , NNS | 3 | P |
| JJ NN NN | 3 | P |
| NN NNP NNP | 3 | P |
| NN NNS NN | 3 | P |
| RB RP NNP | 3 | P |
| NN NN NNP | 3 | P |
| NN NNP NN | 3 | P |
| # CD NN | 3 | P |
| NNS TO NNS | 3 | P |
| NN NN VBD | 3 | P |
| CD NNP NNP | 3 | P |
| JJ NN NNS | 3 | P |
| NN VBG NN | 3 | P |
| NN CD CD | 3 | P |
| NN TO NNP | 3 | P |
| CD NNP NN | 3 | P |
| CD NN NN | 3 | P |
| VBN VBG NN | 3 | P |
| MD VB NN | 3 | P |
| NNS VBP NNS | 3 | P |
| R NNP NNP | 3 | P |
| NN NN NN | 3 | P |
| JJ NN VB | 3 | P |
| NNP NNP NNS | 3 | P |
| NN NN NNS | 3 | P |
| NN VBP NN | 3 | P |
| NNP CC NNP | 3 | P |
| VBG IN VBG | 3 | P |
| NNP NNP VBP | 3 | P |
| NNP CC NNS | 3 | P |
| RB JJ NNP | 3 | P |
| VBN NN NN | 3 | P |
| NNS CD CD | 3 | P |
| VBG NNP NNP | 3 | P |
| NN NNP NNS | 3 | P |
| NN CC NN | 3 | P |
| VBG JJ NN | 3 | P |
| NNP NNP CD | 3 | P |
| RB NN NNS | 3 | P |
| NN NNS VBP | 3 | P |
| NNS VBP NNP | 3 | P |
| NNP CC NN | 3 | P |
| JJ NNS NN | 3 | P |
| RB VBN NN | 3 | P |
| RB IN NNP | 3 | P |
| NN NN VB | 3 | P |
| NN # CD | 3 | P |
| JJ NN VBG | 3 | P |
| JJ NN NNP | 3 | P |
| NNP NNP NNP NNP | 4 | P |
| NN NNP NNP CD | 4 | P |
| NNS VBP NN NNP | 4 | P |
| NNP NNP IN NNP | 4 | P |
| NNS -LRB- NNP -RRB- | 4 | P |
| CD NNP NN NN | 4 | P |
| NNP NNP # CD | 4 | P |
| NNP NNP NNP CD | 4 | P |
| NN CC NN NN | 4 | P |
| # CD NNP NN | 4 | P |
| JJ CC RB NNS | 4 | P |
| NNP DIGITAL NNP NNP | 4 | P |
| NNP NNP NNP VBZ | 4 | P |
| RB JJ NN NN | 4 | P |
| NN VBZ NNP NNP | 4 | P |
| NNP [symbol] NNP NNP | 4 | P |
| NN NN NN NNP | 4 | P |
| NNP NNP NNP VB | 4 | P |
| NN NN VBP NN | 4 | P |
| NN CC NN VBZ | 4 | P |
| NN NNP VBD NN | 4 | P |
| VB NN NN NN | 4 | P |
| NN NN NNP NN | 4 | P |
| NNS IN DT NNP | 4 | P |
| JJ VBG NNP NNP | 4 | P |
| NNP CC VBP NN | 4 | P |
| NNP NNP CD NNP | 4 | P |
| NN VBG NN NN | 4 | P |
| NN SYM : NN | 4 | P |
| IN NNP NNP NNP | 4 | P |
| VBN NN NN NN | 4 | P |
| NN NN VBD NN | 4 | P |
| NN IN DT NN | 4 | P |
| JJ NN NN VBP | 4 | P |
| NN VBD NNP NNP | 4 | P |
| # CD NN NN | 4 | P |
| JJ NN NN CD | 4 | P |
| NN NN NN VBG | 4 | P |
| CD NNP NNP NNP | 4 | P |
| NNP CC NNP NNP | 4 | P |
| VB NN VB NN | 4 | P |
| JJ NN VBP NNS | 4 | P |
| NN NNP NNP VB | 4 | P |
| NNP NNP NNP NNS | 4 | P |
| NNP CD CC CD | 4 | P |
| VBG NN NN NN | 4 | P |
| NN NNP NNP NNP | 4 | P |
| NN NN NNP NNP | 4 | P |
| NNP IN DT NN | 4 | P |
| NN CD NNP NNP | 4 | P |
| # CD NNP NNP | 4 | P |
| NNP RB VBP NN | 4 | P |
| VBG NNP NN NN | 4 | P |
| VBG NN NNP NNP | 4 | P |
| NN NN CC NNP | 4 | P |
| NNP , NNP NNS | 4 | P |
| NNP NNP NNP | 4 | P |
| NNP NNP CC NNP | 4 | P |
| NN CC VBG NN | 4 | P |
| NNP PRP NNP NN | 4 | P |
| NNS CC JJ NNS | 4 | P |
| NN NN VBG NN | 4 | P |
| NN NN NN NN | 4 | P |
| NN NN RB JJ | 4 | P |
| NN NNP NNP NN | 4 | P |
| NN NN CC NN | 4 | P |
| NN NNP P NNP | 4 | P |
| NNS VBP NNP NNP | 4 | P |
| NN VBG NNP NNP | 4 | P |
| CD NN NNP NNP | 4 | P |
| NN NN NN VBP | 4 | P |
| RB NNP NNP NNP | 4 | P |
| NNS VBP NN NN | 4 | P |
| VBG NNP NNP VBZ | 4 | P |
| F NNP NNP NNP | 4 | P |
| NN IN NNP CD | 4 | P |
| NN “” NNP NNP | 4 | P |
| NN NN CC NNS | 4 | P |
| JJ NN NNP NNP | 4 | P |
| NNP TO NNP NNP | 4 | P |
| NNP NNP NNP NN | 4 | P |
| JJ NN NN NNS | 4 | P |
| NN NNP IN NNP | 4 | P |
| VB NN NNP NNP | 4 | P |
| NN NN NN NNS | 4 | P |
| NNP NNPS CC NNP | 4 | P |
| NNS CD CC CD | 4 | P |
| CD CC CD NN | 4 | P |
| JJ JJ NN NN | 4 | P |
| NNP CC NNP NNS | 4 | P |
| VBG NNP NNP NNP | 4 | P |
| NN VBG JJ NN | 4 | P |
| NNP VALVE NNP NNP | 4 | P |
| NN NNS CC NNS | 4 | P |
| NN NN NNP PIPE | 4 | P |
| JJ NN NN NNP | 4 | P |
| NN NN RB NN | 4 | P |
| VBG NN NN NNP | 4 | P |
| NNP -LRB- NNP -RRB- | 4 | P |
| JJ NN NN NN | 4 | P |
| NNS VBP IN NNP | 4 | P |
| NNP NN IN NN | 4 | P |
| NNP NNP TO NNP | 4 | P |
| NN VBG NN HOSE | 4 | P |
| NNP VBZ NN | 4 | P |
| NNP NNP NN NN | 4 | P |
| NNS NNP NNP NN | 4 | P |
| NN NN IN NNP | 4 | P |
| JJ NN VBP NN | 4 | P |
| JJ NN VBG NNS | 4 | P |
| # CD NNP NNP NNP | 5 | P |
| NNP CC NNP NNP NNS | 5 | P |
| JJ NN VBD NNP NNP | 5 | P |
| NN NNP CC NNP NN | 5 | P |
| NN NNP NNP VB NN | 5 | P |
| NN IN NNP # CD | 5 | P |
| NNP NNP NN IN NNP | 5 | P |
| VBG NN NN VBZ NN | 5 | P |
| NN NNP NNP NNP NNP | 5 | P |
| NNP RB NNP NNP NN | 5 | P |
| NN JJ NN NN NN | 5 | P |
| JJ NNP NNPS CC NN | 5 | P |
| NNP IN NNP CD NNS | 5 | P |
| NN NN NN NN NN | 5 | P |
| NNP NNP NNP NNP NNS | 5 | P |
| JJ NN VBG JJ NN | 5 | P |
| NN CC VBG NN NN | 5 | P |
| NN NN NN NNP VB | 5 | P |
| NN NN NNP NNP NNP | 5 | P |
| JJ NN NNP NNP NNP | 5 | P |
| RB CC VB NNP NNP | 5 | P |
| NNP NN IN VBN NNP | 5 | P |
| NNP NNP NNP CC NNP | 5 | P |
| NN NN NN VBP NN | 5 | P |
| NN NN NN JJ NN | 5 | P |
| NN NN NN NNP NNP | 5 | P |
| NN NNS CC JJ NN | 5 | P |
| NNP NNP VBG NN NN | 5 | P |
| # CD NNP NNP NN | 5 | P |
| NN NN CC NN VBP | 5 | P |
| JJ NN NNS CC NN | 5 | P |
| CD NNP NNP NNP NNP | 5 | P |
| JJ NN VBP NN NNS | 5 | P |
| CD NNP NNP IN NNP | 5 | P |
| JJ NN NN CC NN | 5 | P |
| NN VBG NNP NNP NNP | 5 | P |
| NNS -LRB- NNP -RRB- NNP | 5 | P |
| VBG NN NN NNP NNP | 5 | P |
| NNP NNP IN NNP NNP | 5 | P |
| NNP NNP NNPS CC NNPS | 5 | P |
| JJ NNP NNP NNP NN | 5 | P |
| NN NN NNP NNP CD | 5 | P |
| NN NN NN RB NN | 5 | P |
| NNP NNP NNP NNP NNP | 5 | P |
| NNP NNP NNP NNP NN | 5 | P |
| CLUTCH NNP NNP NNP | 5 | P |
| NNP NNP NNP NNP | 5 | P |
| NNP NN NN CC NN | 5 | P |
| NN NNP NNP NNP NN | 5 | P |
| NNP RB VBP NN NN | 5 | P |
| NNS VBP NN NN NN | 5 | P |
| VBG NN NNP NNP NNS | 5 | P |
| R NNP NNP NNP NNP | 5 | P |
| NNP NNP NNPS CC NN | 5 | P |
| NN NN NNP NNP NN | 5 | P |
| NN NN NN CC NN | 5 | P |
| NN NN IN DT NN | 5 | P |
| NNP -LRB- NNP NNP -RRB- | 5 | P |
| NNP NNP NNP : NN | 5 | P |
| JJ NN NN NN NN | 5 | P |
| NN NNP IN DT NN | 5 | P |
| RB JJ NN NN NN | 5 | P |
| NNP NNP NNP VBG NN | 5 | P |
| NNP NNP CC NNP NNP | 5 | P |
| NN NN CC NN NN | 5 | P |
| VBG NN NN NN NN | 5 | P |
| CD NNP NNP IN NNP NNP | 6 | P |
| VB NN NNP NNP NN NN | 6 | P |
| NN NN NNS CC NN NN | 6 | P |
| NNP NNP NNPS CC NNP NNP | 6 | P |
| NN JJ NN NN CC NN | 6 | P |
| NN NN NNP NNP NNP CD | 6 | P |
| RB NNP NNP NNP CC NNS | 6 | P |
| NNP NNP NNP NNP NNP VBP | 6 | P |
| RB CC VB NNP NNP NN | 6 | P |
| NN NNS VBP NNP NNP VBP | 6 | P |
| NN NN NNP NNP NNP NNP | 6 | P |
| NN NN VBP CC VBP NN | 6 | P |
| NNP NNP DT NNP IN NNP | 6 | P |
| JJ NNP NNP -LRB- NNP -RRB- | 6 | P |
| CD NNP IN NNP NNP NNP | 6 | P |
| NNP DRIVE CV HALF NNP NNP | 6 | P |
| NN NN NN -LRB- NNP -RRB- | 6 | P |
| NN NNP NNP NNP OR NNP | 6 | P |
| NNP NNP VBG CC NNP NNP | 6 | P |
| NNP NNP VBG NN NNP NNP | 6 | P |
| NNP NNP NNP NNP NNP VB | 6 | P |
| NN NN NNP NNP CD NNP | 6 | P |
| NN NN RB VBN : NN | 6 | P |
| VBG NN NN CC NN NN | 6 | P |
| NN NN NNP PIPE NNP NNP | 6 | P |
| JJ NN NN NNP NNP NNP | 6 | P |
| NN NN NN CC NN NN | 6 | P |
| NNP NNP NNP : NNP NNP | 6 | P |
| NN NNS CC NN NNP NNP | 6 | P |
| NNP NNP ‘’ NNP “” NN | 6 | P |
| VBG IN CD CC CD NN | 6 | P |
| JJ NNP NNP NNP NNP NNP | 6 | P |
| JJ NN NN VBP NNP NNP | 6 | P |
| NN VBG NN NN NNP NNP | 6 | P |
| NN NN RB SYM : NN | 6 | P |
| NN VBG JJ NN NNP NNP | 6 | P |
| NNP NNP NNP NNP NNP NNP | 6 | P |
| NN NN NNP NNP NNP | 6 | P |
| NN NN NN CC VBP NN | 6 | P |
| JJ , JJ , JJ NNS | 6 | P |
| NN NN RB VBN JJ NN | 6 | P |
| NN NNP NNP NNP NNP NNP | 6 | P |
| NNP NNP NNP CC NNP NNP | 6 | P |
| NNP NNP NNPS CC NN NNS | 6 | P |
| CD NNP NNP NNP NNP NNP | 6 | P |
| NN NNP NNP NNP NNP NN | 6 | P |
| NN NN TO NNP NNP NNP | 6 | P |
| NN NN NN NN NN NN | 6 | P |
| NN NN NNP NNP NNP VB | 6 | P |
| NN VBP JJ NN NN NN | 6 | P |
| NNP NNP NNP NNP NNP NN | 6 | P |
| NNP NNP NNP NNPS CC NN | 6 | P |
| NNP NNP CC NNP NNP NNP | 6 | P |
| NN NN RB VBN : NNP | 6 | P |
| VB NN CC CD NNP NN | 6 | P |
| NNP , NNP NNP , CC NN | More than | P |
| | six | |
| NNP NNP NNP NNP CC NNP NN | More than | P |
| | six | |
| NN NN NNP NNP NNP NNP | More than | P |
| | six | |
| NN NN NNP NNP NNPS CC NN | More than | P |
| | six | |
| NNP CC NNP NNP NNP NNP NNP | More than | P |
| | six | |
| VBG NN NN NNP NNP NNP NNP NNP | More than | P |
| NN | six | |
| NN NNP NNP IN DT NN NN NNP | More than | P |
| | six | |
| NNP NNP DT NN CD NNP NN | More than | P |
| | six | |
| NN CC NN NNP NNP NNP NNP | More than | P |
| | six | |
| NNP NNP NNP NNP NNP NNP NN | More than | P |
| | six | |
| NNP NNP NNP NNP NNP -LRB- NNP | More than | P |
| NNP IN NNP -RRB- | six | |
| NNP NNP , NNP CC NNP NNP NNP | More than | P |
| | six | |
| NN NNP NNP IN NNP NNP NNP | More than | P |
| | six | |
| NN NN , NNP NNP , NNP NNP NNPS CC | More than | P |
| NNP NNP | six | |
| NN CC NN C NNP NNP NNP NNP NN | More than | P |
| | six | |
| CD NNP , NNP NNP , NNP NNP NNP | More than | P |
| | six | |
| JJ NN CC NN NN NN NN NN NN | More than | P |
| | six | |
| NN NN IN DT NN IN DT NN | More than | P |
| | six | |
| NN JJ NN , NNP NNP CC NNP | More than | P |
| | six | |
| NN NN NNP NNP NNP CC NNP | More than | P |
| | six | |
| NNP NNP NNP CC NNP VBP NN | More than | P |
| | six | |
| NN NN TO VB NNPS CC NNPS | More than | P |
| | six | |
| NN NNP NNP , CC NNS CC NN NN | More than | P |
| | six | |
| NNP NNP NNP NNP CC NNP NNP NNP | More than | P |
| | six | |
| NNP NNP NNP NNP NNP OR NNP | More than | P |
| | six | |
| NNP NNP NNP NNP NNPS CC NN | More than | P |
| | six | |
| NN NNP NNP NNP NNP NNP NNP | More than | P |
| | six | |
| NNP NNP , NNP NNP , CC NNS | More than | P |
| | six | |
| NNP NNP NNP NNP NNP NNP NNP | More than | P |
| | six | |
| NN , VBG NN , CC NN | More than | P |
| | six | |
| VBG NN NN NN NN CC NNS | More than | P |
| | six | |
| VBG NNP , NNP NNP , CC NN | More than | P |
| | six | |
| NN NNP NNP VBD NN CC NN NN | More than | P |
| | six | |
| VBG NN NN NNP NNP CC NN | More than | P |
| | six | |
| VBG NNP NNP NNP NNP NNP NNP | More than | P |
| | six | |
| NNP CD NNP NNP NNP # CD | More than | P |
| | six | |
| NN TO NNP NNP NNP NNP NNP | More than | P |
| | six | |
| NNP NNP NNPS CC NNPS NNP NN | More than | P |
| | six | |
| NNP NNP NNP NNP NNP -LRB- IN NNP | More than | P |
| IN NNP - RRB- | six | |
| VB NN VB NNP CC VBG NNP NNP NNP | More than | P |
| NN | six | |
| NNP IN DT NN NNP NNP IN DT NNP | More than | P |
| | six | |
| NN NNP , NNP NNP , REV NNP | More than | P |
| | six | |
| IN NNP NNP , NNP CC NNS | More than | P |
| | six | |

1 In the fields of computational linguistics and probability, an n-gram is a contiguous sequence of n items from a given sequence of text or speech. The items can be phonemes, syllables, letters, words or base pairs according to the application. The n-grams typically are collected from a text or speech corpus. [symbol]
indicates data missing or illegible when filed

TABLE 3
The part of speech tags of the Symptom terms identified
from the corpus used to compute the syntatic similarity
when the domain ontology is unavailable.

| Ngram | NGramType | NGramName |
|---|---|---|
| VBG | 1 | Sy |
| G | 1 | Sy |
| NN | 1 | Sy |
| H | 1 | Sy |
| VBZ | 1 | Sy |
| VBD | 1 | Sy |
| VBN NN | 2 | Sy |
| NN VBD | 2 | Sy |
| VBN NNP | 2 | Sy |
| NNP RB | 2 | Sy |
| NN IN | 2 | Sy |
| RB IN | 2 | Sy |
| DT NNP | 2 | Sy |
| DT NN | 2 | Sy |
| VB NNP | 2 | Sy |
| CD NN | 2 | Sy |
| RB VBG | 2 | Sy |
| VBD IN | 2 | Sy |
| NN RP | 2 | Sy |
| VBD NN | 2 | Sy |
| VBG IN | 2 | Sy |
| VB RB | 2 | Sy |
| NNP NNP | 2 | Sy |
| VB IN | 2 | Sy |
| NNS RB | 2 | Sy |
| NNP CD | 2 | Sy |
| VBG RB | 2 | Sy |
| VBZ NN | 2 | Sy |
| VB NN | 2 | Sy |
| NNP VBG | 2 | Sy |
| NNP NNP RP | 3 | Sy |
| VB WRB NN | 3 | Sy |
| JJ TO VB | 3 | Sy |
| VBZ IN NN | 3 | Sy |
| NNP UH VB | 3 | Sy |
| RB VBG RB | 3 | Sy |
| VBN NN NN | 3 | Sy |
| MD RB VB | 3 | Sy |
| NNP TO NN | 3 | Sy |
| JJ CC JJ | 3 | Sy |
| NN VBZ NNP | 3 | Sy |
| VBG JJ NNP | 3 | Sy |
| JJ NN NN | 3 | sy |
| VBZ NNP NNP | 3 | Sy |
| VBG NNP NNS | 3 | Sy |
| VBN CC VBN | 3 | Sy |
| NN IN NN | 3 | Sy |
| VB DT NN | 3 | Sy |
| DT NNP NNP | 3 | Sy |
| NNS VBP NNP | 3 | Sy |
| MD VB NN | 3 | Sy |
| NNS TO NNP | 3 | Sy |
| NNP : NN | 3 | Sy |
| NNP NNS VBG | 3 | Sy |
| NNS VBP VBG | 3 | Sy |
| VBG TO NNP | 3 | Sy |
| DT NNP NNS | 3 | Sy |
| NN NN NN | 3 | Sy |
| VBZ NNP IN | 3 | Sy |
| NNP TO NNP | 3 | Sy |
| DT NNP VBD | 3 | Sy |
| JJ NNP NN | 3 | Sy |
| NNS VBD NNP | 3 | Sy |
| VB IN NNP | 3 | Sy |
| NN NNP NNP | 3 | Sy |
| DT NNS VBD | 3 | Sy |
| NN IN NNP RP | 4 | Sy |
| NNP NNP VBP NN | 4 | Sy |
| NNP “” NNP NNP IN | 4 | sy |
| NNP NNP NNP IN | 4 | Sy |
| JJ NN IN VBG | 4 | Sy |
| JJ RP CC NNS | 4 | Sy |
| NNP NNP NNP NN | 4 | Sy |
| NNP IN DT NN | 4 | Sy |
| NNP NNP NNP NNS | 4 | Sy |
| NNP NNP CD NNP | 4 | Sy |
| IN NNP NNP NNS | 4 | Sy |
| NN , UH NNP | 4 | Sy |
| VB NNP NNP NN | 4 | Sy |
| NNP NNP VBD NNP | 4 | Sy |
| NNP NNP RB RB | 4 | Sy |
| DT NNP NNP NN | 4 | Sy |
| NN NNP NNP RB | 4 | Sy |
| MD RB VB NN | 4 | Sy |
| NN NN VBZ VBG | 4 | Sy |
| VBG WRB IN NNP | 4 | Sy |
| MD RB VB NNS | 4 | Sy |
| VBD TO DT NN | 4 | Sy |
| JJ IN NNP NNP | 4 | Sy |
| NNP NNP WRB NN | 4 | Sy |
| NNP NNP NNP RP | 4 | Sy |
| JJ NN VBD NN | 4 | Sy |
| MD RB VB RB | 4 | Sy |
| NN RP RB RB | 4 | Sy |
| NNP NNP VBZ NNP | 4 | Sy |
| VBG NN IN NNP | 4 | Sy |
| NNP NNP VB NNP | 4 | Sy |
| RB NNP NNP NNP | 4 | Sy |
| NN VBZ RB VBN | 4 | Sy |
| VBG NNP IN NNP | 4 | Sy |
| NNP TO VB IN | 4 | Sy |
| MD VB CC RB VB | 5 | Sy |
| VBN IN VBG IN PRP | 5 | Sy |
| VB NN IN NN NN | 5 | Sy |
| VBG NNP IN NNP NNP | 5 | Sy |
| RB NNP NNP VBZ IN | 5 | Sy |
| NNP IN DT NN NN | 5 | Sy |
| MD RB VB JJ NN | 5 | Sy |
| DT NNP IN NNP NNP | 5 | Sy |
| MD RB VB IN NNP | 5 | Sy |
| NNP NNP NNP NNP NNP | 5 | Sy |
| RB VBG NNP IN NNP | 5 | Sy |
| NNP NNP DT NN NN | 5 | Sy |
| RB NN VBD VBN NNP | 5 | Sy |
| NN NN IN CD NN | 5 | Sy |
| RB VBG TO NNP NNP | 5 | Sy |
| NN NN IN JJ NN | 5 | Sy |
| VBG NN NNS VBG IN | 5 | Sy |
| RB NN NNS RB VBG | 5 | Sy |
| UH CD NNP TO NNP | 5 | Sy |
| NN NN VBG NNP NNP | 5 | Sy |
| NN TO NNP NNP PRP NN | 6 | Sy |
| VBG NN MD RB VB NNP | 6 | Sy |
| NN NN NNS VBP VBG IN | 6 | Sy |
| NNP CD NNP NNP DT NN | 6 | Sy |
| NN NN VB NN VBZ IN | 6 | Sy |
| VBG NNS VBP NNP DT NN | 6 | Sy |
| NNP NNP CC NNP WRB VBG | 6 | Sy |
| MD RB VB NNP NNP CD | 6 | Sy |
| VB NNP NNP TO NNP RP | 6 | Sy |
| NNP NNP NNP NNP NNP NNP | 6 | Sy |
| NN IN NNP NNP RB NNS | 6 | Sy |
| NNP NNP VBD NNP NNP NNP | 5 | Sy |
| NNP NNP WRB NN VBZ VBN | 6 | Sy |
| NNP NNP NNP RP NNP NNP VBZ NNP | More than | Sy |
| | six | |
| MD RB VB IN NNP TO IN | More than | Sy |
| | six | |
| NNP NNP NNP NNP NNP WRB NN | More than | Sy |
| | six | |
| MD VB RB IN VBG NN NNP NNP | More than | Sy |
| | six | |
| NNP NNP NNP NNP IN NNP NNP | More than | Sy |
| | six | |
| VB IN NNP NNP IN NNP NNS | More than | Sy |
| | six | |
| MO RB VB NNP NNP NNP NNP NNP | More than | Sy |
| NNP NNP | six | |
| VB NNP NNP NNP TO DT NNP | More than | Sy |
| | six | |
| NNP NNP TO VB NN NN 4 NNP | More than | Sy |
| | six | |
| JJ NN VBG IN NN TO NNP | More than | Sy |
| | six | |
| NN NNP NNP IN NNP NNP NNP | More than | Sy |
| | six | |

TABLE 4
The part of speech tags of the Failure mode terms identified
from the corpus used to compute the syntatic similarity
when the domain ontology is unavailable.

| Ngram | NGramType | NGramName |
|---|---|---|
| VB | 1 | FM |
| JJ | 1 | FM |
| VBN | 1 | FM |
| RB | 1 | FM |
| IN | 1 | FM |
| CD | 1 | FM |
| NNS | 1 | FM |
| NNS VBG | 2 | FM |
| VBD NNP | 2 | FM |
| NNP RP | 2 | FM |
| VBN NNS | 2 | FM |
| NNP VBD | 2 | FM |
| NN NN | 2 | FM |
| JJ NN | 2 | FM |
| JJ NNS | 2 | FM |
| NNP NN | 2 | FM |
| VBG NN | 2 | FM |
| RB NN | 2 | FM |
| NNP IN | 2 | FM |
| IN NNP | 2 | FM |
| VBZ NNP | 2 | FM |
| RB VB | 2 | FM |
| NNSVBP | 2 | FM |
| DT NNS | 2 | PM |
| RB VBN | 2 | FM |
| VBZ IN | 2 | FM |
| NN NNS | 2 | FM |
| NNP NNP NN | 3 | FM |
| NNP N VBG | 3 | FM |
| NN IN NNP | 3 | FM |
| NNP RB VBP | 3 | FM |
| NNP VBZ NNP | 3 | FM |
| JJ TO NN | 3 | FM |
| NNP VBD IN | 3 | FM |
| NN NN VBG | 3 | FM |
| NNP IN NNP | 3 | FM |
| NNP VBD NNP | 3 | FM |
| NNS NNP NNP | 3 | FM |
| NN NN IN | 3 | FM |
| VBD IN VBG | 3 | FM |
| JJ VBZ NNP | 3 | FM |
| NN NNS IN | 3 | FM |
| NN NN NNS | 3 | FM |
| NN TO NNP | 3 | FM |
| DT NN NN | 3 | FM |
| JJ NN NNS | 3 | FM |
| NN NN VB | 3 | FM |
| NNP NNP NNP | 3 | FM |
| NNP RB VBG | 3 | FM |
| NNP CC NNP | 3 | FM |
| NNP VBZ IN | 3 | FM |
| NN VBD NN | 3 | FM |
| NN NN NNP | 3 | FM |
| VBN IN NN | 3 | FM |
| NNP VBD VBG | 3 | FM |
| VBG DT NNS | 3 | FM |
| RB RB VBG | 3 | FM |
| JJ TO NNP | 3 | FM |
| RB VB RB | 3 | FM |
| VBG NN | 3 | FM |
| VBG IN NNP | 3 | FM |
| NN TO CD | 3 | FM |
| VBN NNPS IN NNP | 4 | FM |
| VBZ TO VB NN | 4 | FM |
| NN VBZ RB RB | 4 | FM |
| NNP TO NNP NNP | 4 | FM |
| RB VBG NN NN | 4 | FM |
| VBG NN IN IN | 4 | FM |
| NNP VBZ RB JJ | 4 | FM |
| VBG NN RB VBZ | 4 | FM |
| VBZ DT NNP NNP | 4 | FM |
| NNP IN NNP NNP | 4 | FM |
| NNP NNP NNP NNP | 4 | FM |
| RB VBN IN NNP | 4 | FM |
| MD RB VB IN | 4 | FM |
| NN NN VBD NNP | 4 | FM |
| NNP NNP TO RB | 4 | FM |
| JJ TO NNP NNP | 4 | FM |
| DT NNP UH NNP | 4 | FM |
| NNP NNP VBG NN | 4 | FM |
| NN VBZ VBG NN | 4 | FM |
| NNP “” NNP NNP | 4 | FM |
| DT NNP NNP VB | 4 | FM |
| DT NNP NNP NNP | 4 | FM |
| MD RB VB RP | 4 | FM |
| NN TO VB NNP | 4 | FM |
| NNP NNP NN NN | 4 | FM |
| UN NNPS IN NNP | 4 | FM |
| VBG IN VBG NN | 4 | FM |
| NN IN NNP NNP | 4 | FM |
| NN NN NN NN | 4 | FM |
| NN 2 NNP NNP | 4 | FM |
| NN TO VB VBN | 4 | FM |
| MD RB VB TO NNP | 5 | FM |
| NNP NNP NNP IN NNP | 5 | FM |
| NNP DT NNP NNP NNP | 5 | FM |
| NNP NNP IN NNP NNP | 5 | FM |
| VBG NNS NNP NNP NNP | 5 | FM |
| RB VBZ IN NNP NNP | 5 | FM |
| NNP NNP NNP CC NNP | 5 | FM |
| JJ IN DT NNP NN | 5 | FM |
| VBG NN NNP , NNP | 5 | FM |
| MD RB VB VBG NN | 5 | FM |
| NNP NNP VBD TO VB | 5 | FM |
| MD RB VB NNP CD | 5 | FM |
| JJ NNP NNP NNP NN | 5 | FM |
| NN VBZ DT NNP NNP | 5 | FM |
| NNP NNP VBP DT NN | 5 | FM |
| RB VBG NNP NNP NNP | 5 | FM |
| JJ IN VBG VBN IN | 5 | FM |
| NNP NNP IN DT NN | 5 | FM |
| NNS VBP IN DT NNS | 5 | FM |
| NN NN NN VBD IN | 5 | FM |
| VBG NN VBZ NNP DT NN | 6 | FM |
| DT CD NNP NNP TO NNP | 6 | FM |
| NNP NNP VB NNP IN NNP | 6 | FM |
| VBG NNP # CD VBZ NNP | 6 | FM |
| NN MD RB VB TO NNP | 6 | FM |
| DT NNP NNP NNP NNP NNP | 6 | FM |
| DT NNP NNP IN NNP NNP | 6 | FM |
| VBN CD NNS IN DT NN | 6 | FM |
| NNP NNP VBZ NNP DT NN | 6 | FM |
| NNP IN RB VBN NN NN | 6 | FM |
| NN NN RB JJ VBZ IN | 6 | FM |
| VB WRB VBG TO DT NN | 6 | FM |
| RB NNP NNP VBZ NNP NNP | 6 | FM |
| NN NNP TO VB NNP NNP NNP NN NNP | More than | FM |
| NNP VBZ RB VB | six | |
| NNP RB VBP IN NNP NNP IN NNP | More than | FM |
| | six | |
| NN VBG NNP MD RB VB NNP | More than | FM |
| | six | |
| VBG NNS NNP NNP IN NNP NNP NNP | More than | FM |
| | six | |
| NNS IN CC NNP IN NNP VBD | More than | FM |
| | six | |
| NNP CC RB VBZ JJ VBN NN | More than | FM |
| | six | |
| NNP NNP NNP IN DT NN NN | More than | FM |
| | six | |
| NNP “” NNP NNP NNP IN NNP | More than | FM |
| | six | |
| VB NN WRB VBG CC VBG NNP | More than | FM |
| | six | |
| NNP NNP NNP TO NNP CC NNP VBZ NN | More than | FM |
| | six | |

TABLE 5
The part of speech tags of the Action terms identified
from the corpus used to compute the syntactic similarity
when the domain ontology is unavailable.

| Ngram | NGramType | NGramName |
|---|---|---|
| NN | 1 | A |
| CD | 1 | A |
| NNS | 1 | A |
| R | 1 | A |
| VB | 1 | A |
| JJ | 1 | A |
| RB | 1 | A |
| NNP | 1 | A |
| VBG | 1 | A |
| VBN | 1 | A |
| VBD | 1 | A |
| JJ NN | 2 | A |
| NN NNS | 2 | A |
| NN NNP | 2 | A |
| VBN NNS | 2 | A |
| RB VB | 2 | A |
| VB NN | 2 | A |
| NNP NNS | 2 | A |
| CD NNP | 2 | A |
| JJ NNS | 2 | A |
| NNP NNP | 2 | A |
| NN NN | 2 | A |
| NNP RP | 2 | A |
| VB CC NNS | 3 | A |
| NNS CC VBD | 3 | A |
| NN CC NNS | 3 | A |
| NNP NNP NNP | 3 | A |
| NN NN NN | 3 | A |
| NNS CC NNS | 3 | A |
| JJ CC NN | 3 | A |
| VBN TO NNP | 3 | A |
| NN CC NN | 3 | A |
| NNS CC VBP | 3 | A |
| VB CC NN | 3 | A |
| NN NN VB | 3 | A |
| NN NNP NN | 3 | A |
| VBN CC VBN | 3 | A |
| NN CC VB | 3 | A |
| NN NNP NNP NNS | 4 | A |
| NN NN TO NNP | 4 | A |
| NN VBD NNP NNP | 5 | A |
| NNP | | |

A determination is made at 810 as to whether the symptoms and failure modes are new. In accordance with one embodiment, when the repeat visit cases are compared, the data related either to the same vehicle that is involved in the repeat visit is considered, and the process may also take into account other relevant features, such as age, mileage or age/mileage of the observed vehicle, along with the vehicle identification number (VIN). This may be used to identify all other vehicles with the same features and we can better estimate impact of the symptoms or the failure modes on the vehicle populations. Moreover, the VIN information may help to identify the manufacturing plant and the shift in which that specific VIN is manufactured. In certain embodiments, all other VINs from the same plant manufacturing within t days are extracted from the data to extract the symptoms and the failure modes associated with them with related age, mileage or age/mileage data exposure. This comparison with respect to the legacy data may be particularly helpful to facilitate a determination as to whether any of the symptoms or the failure modes or their combination thereof are new from the ones observed in the legacy data or the wide spread implications of the observed symptoms or failure modes. All the newly identified symptoms or failure modes can act as a useful source of information for a DFMEA process, system, or team to modify the existing system design. Moreover, these newly identified symptoms or failure modes are also included in the next generation DFMEA to ensure that the future vehicle population that will be built using modified DFMEA will have less number of faults/failures associated with the same parts/components. In addition, in various embodiments, the newly identified symptoms and failure modes involved in the repeat visit cases, are also used to improve the service documents as well as the technician service bulletins to help field technicians handle faults effectively and correctly. In various embodiments, the root causes and the fixes related to these newly identified symptoms or failure modes are included in the service documents as well as the technician service bulletins. Also in various embodiments, this provides an in-time assist for field technicians to fix the vehicle, which are observed with such signatures.

In certain embodiments, to compare the symptoms and failure modes observed in the repeat visit vehicle with the ones present in the legacy data with the same data exposure of age, mileage, or age/mileage, etc., the following semantic similarity metric is used, as described in the paragraphs below.

While comparing two symptom or failure mode terms, Tᵢ and Tⱼ, the context information associated with these symptoms is collected. Function shown in the following Equation 12 is used to compute the similarity.

$$\begin{matrix}{sim}^{w} ( {T}_{i} , {T}_{j} ) - \frac{1}{2} ( \frac{{\sum }_{w ∈ {T}_{j}} ( max Sim ( w , {T}_{j} ) )}{\text{?} idf ( w )} + \frac{{\sum }_{w ∈ {T}_{i}} ( max Sim ( w , {T}_{i} ) )}{\text{?} idf ( w )} ) & ( Equation 12 ) \\ \text{?} \text{indicates text missing or illegible when filed} & \end{matrix}$$

where, maxSim(w, Tⱼ), the maximum similarity between a word from Tᵢ, i.e. wεTᵢ with all the relevant words from Tⱼ (for example, if we are comparing two failure modes then a word that is a member of one failure mode can be compared only with all other words that are member of a failure mode). The term idf(w), the inverse document frequency, estimates the total number of documents in the corpus divided by the documents consisting of w.

Next, the maximum similarity of a term, w from a collocate T is compared with each of the term, tⱼ from a collocate Tⱼ extracted from the unstructured data by using Equation (10) above, as follows:

maxSim(w,Tⱼ)A=maxᵢ(sim(wᵢtⱼ), where tⱼεTⱼ (Equation 13)

Subsequently, the Text-to-Text similarity between Tᵢ and Tⱼ is calculated by using Eq. (11), as follows:

$$\begin{matrix}\text{?} ( {T}_{i} , {T}_{j} ) = \frac{1}{2} ( \frac{\text{?} ( max Sim ( t , {T}_{j} ) )}{\text{?} idf ( t )} + \frac{\text{?} ( max Sim ( t , {T}_{i} ) )}{\text{?} idf ( t )} ) & ( Equation 14 ) \\ \text{?} \text{indicates text missing or illegible when filed} & \end{matrix}$$

where, maxSim(tᵢ Tⱼ), the maximum similarity between a tuple ‘t’ associated with a collocate Tᵢ with all other tuples associated with collocate Tⱼ. The same process is used to compute the maximum similarity maxSim(t, Tᵢ) by using each tuple ‘t’ associated with Tⱼ with all the tuples associated with collocate Tᵢ.

If it is determined at 810 that the symptoms and failure modes are new, then the DFMEA database is updated accordingly at 812. Specifically, in one embodiment, the combination(s) of symptoms with failure modes that have caused the repeat visits are included in the DFMEA document, and the DFMEA data is updated accordingly to include the repeat visit cases, to provide additional information for the design engineers to improve the product design. Also in one embodiment, when the vehicle makes a visit to the dealership and in any of these visits the symptoms observed have safety critical implications then their associated failure modes are identified by comparing them with other internal data such as service manuals, technician bulletins, etc. and this information is used to include/update the DFMEAs.

Conversely, if it is determined at 810 that the symptoms and failure modes are not new, then the DFMEA database is not updated. Specifically, no repeat visit cases are used to update the DFMEA, and the process 800 terminates at 814.

Accordingly, per the discussions above, in various embodiments syntactic similarity analysis is performed in cases where semantic information in the form of domain knowledge is either not available information. As set forth in greater detail above, in various embodiments various unique part of speech tags identified and utilized to perform the syntactic similarity between any two documents, i.e., DFMEA and the warranty data. In contrast to other techniques, in various embodiments Applicant's approach takes into account the part of speech tags as the syntactic information to perform similarity. Also as discussed above, in various embodiments Applicant's approach identifies vehicle repeat visit cases. In addition, also as discussed above, in various embodiments Applicant's approach not only relies on the semantic similarity but also exploits the syntactic information, for example as discussed above.

Also per the discussions above, in contrast to other techniques, in various embodiments of Applicant's approach the abbreviated terms are disambiguated systematically before the semantic similarity between these terms is calculated. This may be useful, for example, in helping to consider only the relevant context information co-occurring with the terms which are going to be compared. Moreover, in various embodiments Applicant's approach employs the semantic similarity to identify the vehicle with the repeat visit cases. Moreover, in various embodiments the symptom or the failure modes observed in the repeat visit cases are used to successfully augment the related service manuals, technician service bulletins, and so on along with their root causes and the fixes. In various embodiments this provides in time support for the field technicians to fix the vehicles observed with the relevant symptoms and failure modes.

Also per the discussions above, in various embodiments, when the domain ontology is available, the domain ontology is used to identify the critical technical phrases, and the critical technical phrases are used to calculate the “Semantic Similarity”. Also per the discussions above, in various embodiments, when the domain ontology is unavailable, then only in such circumstances the “Syntactic Similarity” is calculated.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

1. A method comprising:
obtaining first data comprising data elements pertaining to a first plurality of vehicles;
obtaining second data comprising data elements pertaining to a second plurality of vehicles, wherein one or both of the first data and the second data include one or more abbreviated terms;
disambiguating the abbreviated terms at least in part by:
identifying, from a domain ontology stored in a memory, respective basewords that are associated with each of the abbreviated terms;
filtering the basewords;
performing a set intersection of the basewords; and
calculating posterior probabilities for the basewords based at least in part on the filtering and the set intersection; and
combining the first data and the second data, via a processor, based on semantic and syntactic similarity between respective data elements of the first data and the second data and the disambiguating of the abbreviated terms.

2. The method of claim 1, wherein:
the first data comprises design failure mode and effects analysis (DFMEA) data that is generated using vehicle warranty claims; and
the second data comprises vehicle field data.

3. The method of claim 2, further comprising:
determining whether any particular failure modes have resulted in multiple warranty claims for the vehicle, based on the DFMEA data and the vehicle field data; and
updating the DFMEA data based on the multiple warranty claims for the vehicle caused by the particular failure modes.

4. The method of claim 2, wherein:
the DFMEA data includes the one or more abbreviated terms;
the step of disambiguating the abbreviated terms comprises disambiguating the abbreviated terms in the DFMEA data at least in part by:
identifying, from a domain ontology stored in a memory, respective basewords that are associated with each of the abbreviated terms of the DFMEA data;
filtering the basewords;
performing a set intersection of the basewords; and
calculating posterior probabilities for the basewords based at least in part on the filtering and the set intersection; and
combining the first data and the second data, via a processor, based on syntactic similarity between respective data elements of the first data and the second data and the disambiguating of the abbreviated terms of the DFMEA data.

5. The method of claim 2, wherein:
the vehicle warranty data includes the one or more abbreviated terms;
the step of disambiguating the abbreviated terms comprises disambiguating the abbreviated terms in the vehicle warranty data at least in part by:
identifying, from a domain ontology stored in a memory, respective basewords that are associated with each of the abbreviated terms of the vehicle warranty data;
filtering the basewords;
performing a set intersection of the basewords; and
calculating posterior probabilities for the basewords based at least in part on the filtering and the set intersection; and
combining the first data and the second data, via a processor, based on semantic and syntactic similarity between respective data elements of the first data and the second data and the disambiguating of the abbreviated terms of the vehicle warranty data.

6. The method of claim 1, wherein the step of combining the first data and the second data comprises:
calculating, via the processor, a measure of syntactic similarity pertaining to respective data elements of the first data and the second data, based at least in part on the and the disambiguation of the abbreviated terms; and
determining, via the processor, that the respective data elements of the first data and the second data are related to one another based on the calculated measure of the semantic and syntactic similarity.

7. The method of claim 6, wherein the step of calculating the measure of the semantic and syntactic similarity comprises calculating, via the processor, the measure of semantic and syntactic similarity between terms associated with vehicle symptoms derived from the respective data elements of the first data and the second data, based at least in part on the and the disambiguation of the abbreviated terms.

8. The method of claim 6, wherein:
the step of calculating the measure of the syntactic similarity comprises calculating, via the processor, a Jaccard Distance between terms derived from the respective data elements of the first data and the second data, based at least in part on the and the disambiguation of the abbreviated terms; and
the step of determining that the respective data elements are related comprises determining, via the processor, that the respective data elements of the first data and the second data are related if the Jaccard Distance exceeds a predetermined threshold.

9. The method of claim 8, wherein the step of determining that the respective data elements are related comprises:
determining, via the processor, that the respective data elements of the first data and the second data are synonymous if the Jaccard Distance exceeds the predetermined threshold.

10. The method of claim 8, wherein:
the respective data elements of the first data and the second data comprise strings representing vehicle parts, vehicle systems, and vehicle actions; and
the step of calculating the Jaccard Distance comprises calculating, via the processor, the Jaccard Distance between the respective strings of the respective data elements of the first data and the second data, based at least in part on the and the disambiguation of the abbreviated terms.

11. A method comprising:
obtaining first data comprising data elements pertaining to a first plurality of vehicles, the first data comprising design failure mode and effects analysis (DFMEA) data that is generated using vehicle warranty claims;
obtaining second data comprising data elements pertaining to a second plurality of vehicles, the second data comprising vehicle field data;
combining the DFMEA data and the vehicle field data, based on syntactic similarity between respective data elements of the DMEA data and the vehicle field data;
determining whether any particular failure modes have resulted in multiple warranty claims for the vehicle, based on the DFMEA data and the vehicle field data; and
updating the DFMEA data based on the multiple warranty claims for the vehicle caused by the particular failure modes.

12. The method of claim 11, wherein the DFMEA data, the warranty data, or both, include one or more abbreviated terms, and the process further comprises:
disambiguating the abbreviated terms at least in part by:
identifying, from a domain ontology stored in a memory, respective basewords that are associated with each of the abbreviated terms;
filtering the basewords;
performing a set intersection of the basewords; and
calculating posterior probabilities for the basewords based at least in part on the filtering and the set intersection;
wherein the step of combining the DFMEA data and the vehicle field data comprises combining the DFMEA data and the vehicle field data based on syntactic similarity between respective data elements of the DMEA data and the vehicle field data and the disambiguating of the abbreviated terms.

13. The method of claim 11, wherein the DFMEA data includes the one or more abbreviated terms, and the process further comprises:
disambiguating the abbreviated terms of the DFMEA data at least in part by:
identifying, from a domain ontology stored in a memory, respective basewords that are associated with each of the abbreviated terms of the DFMEA data;
filtering the basewords;
performing a set intersection of the basewords; and
calculating posterior probabilities for the basewords based at least in part on the filtering and the set intersection;
wherein the step of combining the DFMEA data and the vehicle field data comprises combining the DFMEA data and the vehicle field data based on semantic and syntactic similarity between respective data elements of the DMEA data and the vehicle field data and the disambiguating of the abbreviated terms of the DFMEA data.

14. The method of claim 11, wherein the vehicle warranty data includes the one or more abbreviated terms, and the process further comprises:
disambiguating the abbreviated terms of the vehicle warranty data at least in part by:
identifying, from a domain ontology stored in a memory, respective basewords that are associated with each of the abbreviated terms of the vehicle warranty data;
filtering the basewords;
performing a set intersection of the basewords; and
calculating posterior probabilities for the basewords based at least in part on the filtering and the set intersection;
wherein the step of combining the DFMEA data and the vehicle field data comprises combining the DFMEA data and the vehicle field data based on syntactic similarity between respective data elements of the DMEA data and the vehicle field data and the disambiguating of the abbreviated terms of the vehicle warranty data.

15. A system comprising:
a memory storing:
first data comprising data elements pertaining to a first plurality of vehicles;
second data comprising data elements pertaining to a second plurality of vehicles wherein one or both of the first data and the second data include one or more abbreviated terms; and
a processor coupled to the memory and configured to at least facilitate:
disambiguating the abbreviated terms at least in part by:
identifying, from a domain ontology stored in a memory, respective basewords that are associated with each of the abbreviated terms;
filtering the basewords;
performing a set intersection of the basewords; and
calculating posterior probabilities for the basewords based at least in part on the filtering and the set intersection; and
combining the first data and the second data, via a processor,
based on syntactic similarity between respective data elements of the first data and the second data and the disambiguating of the abbreviated terms.

16. The system of claim 15, wherein the processor is further configured to:
calculate a measure of semantic and syntactic similarity between respective data elements of the first data and the second data, based at least in part on the and the disambiguation of the abbreviated terms; and
determine that the respective data elements of the first data and the second data are related to one another based on the calculated measure of the semantic and syntactic similarity.

17. The system of claim 16, wherein the processor is further configured to:
calculate a Jaccard Distance between respective data elements of the first data and the second data, based at least in part on the and the disambiguation of the abbreviated terms; and
determine that the respective data elements of the first data and the second data are related if the Jaccard Distance exceeds a predetermined threshold.

18. The system of claim 17, wherein:
the respective data elements of the first data and the second data comprise strings representing vehicle parts, vehicle systems, and vehicle actions; and
the processor is further configured to calculate the Jaccard Distance between the respective strings of the respective data elements of the first data and the second data, based at least in part on the and the disambiguation of the abbreviated terms.

19. The system of claim 15, wherein
the first data comprises design failure mode and effects analysis (DFMEA) data that is generated using vehicle warranty claims; and
the second data comprises vehicle field data.

20. The system of claim 19, wherein the processor is configured to at least facilitate:
determining whether any particular failure modes have resulted in multiple warranty claims for the vehicle, based on the DFMEA data and the vehicle field data; and
combining the first data and the second data, via a processor, based on syntactic similarity between respective data elements of the first data and the second data and the disambiguating of the abbreviated terms.
